(19) United States
(12) Patent Application Publication
(10) Pub. No.: US 2025/0007378 A1
(43) Pub. Date: Jan. 2, 2025

(54) ROTARY LIFTING ACTUATOR

(71) Applicant: FERTIG Motors GmbH, Marktheidenfeld (DE)

(72) Inventor: Valentin Karnehm, Würzburg (DE)

(21) Appl. No.: 18/882,257

(22) Filed: Sep. 11, 2024

Related U.S. Application Data
(63) Continuation of application No. PCT/EP2023/025120, filed on Mar. 16, 2023.

(30) Foreign Application Priority Data
Mar. 16, 2022 (DE) 10 2022 106 169.6

(51) Int. Cl. H02K 41/03

(52) U.S. Cl. CPC H02K 41/031

(57) ABSTRACT

In a rotary lifting actuator, the polarity of the permanent magnets of the rotor alternates in such a way that a checkerboard pattern is created. The controller of the rotary lifting actuator is configured to energize the coils of hollow cylinder sections of the stator for the rotary movement of the rotor such that a traveling magnetic field is generated along the hollow cylinder sections. The energized coil rows along the hollow cylinder sections are at least partially energized alternately in opposite directions, and/or the controller is configured to energize the coils of the hollow cylinder sections of the stator for the lifting movement of the rotor such that a traveling magnetic field is generated transversely with regard to the hollow cylinder sections, the energized coil rows being energized transversely with regard to the hollow cylinder sections at least partially alternately in opposite directions.

### CROSS-REFERENCE TO RELATED APPLICATIONS

This patent application is a continuation of International Patent Application No. PCT/EP2023/025120, filed Mar. 16, 2023, entitled “Rotating-Lifting Actuator,” which claims the priority of German patent application DE 10 2022 106 169.6, filed Mar. 16, 2022, entitled “Dreh-Hub-Aktuator,” each of which is incorporated by reference herein, in the entirety and for all purposes.

### FIELD

The invention relates to a rotary lifting actuator.

### BACKGROUND

A large number of applications in automation technology require combined turning and lifting movements. This applies, for example, to screwing in a screw or screwing a lid onto a container. In addition, it is frequently required to rotate an object by a certain angle as part of a manufacturing or working process. In order to do so, the object must be gripped, lifted, rotated and then set down again. The overall process thus involves at least one turning movement and several lifting movements.

Rotary lifting actuators, in which a rotary motor and a linear motor are mechanically connected, are frequently used to carry out combined rotary and lifting movements. The rotary movement and the linear movement of the actuator shaft of the rotary lifting actuator are carried out by the mechanical combination of the two independent motors.

EP 2 733 830 A1, for example, discloses a rotary lifting actuator in which a linear motor is placed in front of a rotary motor. The rotary motor comprises a hollow rotor through which an actuator shaft is guided and which is kinematically coupled to the actuator shaft. The linear motor comprises a rotor arranged coaxially to the actuator shaft, which is kinematically coupled to the actuator shaft in relation to the axial movement of the rotor.

EP 3 300 229 A1 describes a further rotary lifting actuator in which a linear motor is arranged laterally next to a rotary motor, with the longitudinal axis of an actuator shaft extending through a hollow rotor of the rotary motor being aligned in parallel to the axis of movement of a rotor of the linear motor. The longitudinal ends of the actuator shaft and rotor are mechanically coupled in such a way that the axial movement of the rotor is transmitted to the actuator shaft.

The rotary motor and linear motor in the known rotary lifting actuators are two separate motors, which requires a large installation space and also leads to a high level of inertia when carrying out combined rotary and linear movements. The wear on the mechanical components also adds up due to the two motors.

There is a need to provide a compact and low-wear rotary lifting actuator with reduced inertia.

### SUMMARY

According to an aspect, a rotary lifting actuator comprises a hollow cylindrical stator and a rotor which is arranged coaxially in the hollow cylindrical stator, and a controller. The stator comprises a plurality of hollow cylinder sections, each hollow cylinder section comprising a plurality of coils arranged over the hollow cylinder section circumference in a distributed manner. The rotor comprises a plurality of shaft sections, wherein each shaft section comprises a plurality of permanent magnets arranged over the shaft section circumference in a distributed manner, wherein the polarity of the permanent magnets of the rotor alternates in such a way that a checkerboard pattern is produced.

The controller is embodied to energize the coils of the hollow cylinder sections of the stator for the rotary movement of the rotor in such a way that a traveling magnetic field is generated along the hollow cylinder sections, wherein the energized coil rows along the hollow cylinder sections are at least in part energized alternately in opposite directions, and/or the controller is embodied to energize the coils of the hollow cylinder sections of the stator for the lifting movement of the rotor in such a way that a traveling magnetic field is generated transversely with regard to the hollow cylinder sections, the energized coil rows being energized transversely with regard to the hollow cylinder sections at least partially alternately in opposite directions.

According to another aspect, a rotary lifting actuator comprises a hollow cylindrical stator and a rotor which is arranged coaxially in the hollow cylindrical stator, and a controller. The stator comprises a plurality of hollow cylinder sections, each hollow cylinder section comprising a plurality of coils arranged over the hollow cylinder section circumference in a distributed manner. The rotor comprises a plurality of shaft sections, wherein each shaft section comprises a plurality of permanent magnets arranged over the shaft section circumference in a distributed manner, wherein the polarity of the permanent magnets of the rotor alternates in such a way that a checkerboard pattern is produced.

The coils are operated in a three-phase alternating current mode, wherein each hollow cylinder section comprises three coils or an N-fold of the three coils, respectively, on its circumference in a distributed manner, wherein three hollow cylinder sections or an N-fold of the three hollow cylinder sections are provided in the longitudinal direction of the hollow cylindrical stator, and wherein an outer circumferential surface of the rotor spanned by four permanent magnets in two shaft sections of the rotor is covered by an inner circumferential surface of the stator spanned by the nine coils in three hollow cylinder sections of the stator.

According to another aspect, a rotary lifting actuator comprises a hollow cylindrical stator and a rotor which is arranged coaxially in the hollow cylindrical stator, and a controller. The stator comprises a plurality of hollow cylinder sections, each hollow cylinder section comprising a plurality of coils arranged over the hollow cylinder section circumference in a distributed manner. The rotor comprises a plurality of shaft sections, wherein each shaft section comprises a plurality of permanent magnets arranged over the shaft section circumference in a distributed manner, wherein the polarity of the permanent magnets of the rotor alternates in such a way that a checkerboard pattern is produced.

The permanent magnets form a ring on the shaft section circumference of each shaft section, wherein the permanent magnets on the shaft section circumference of the shaft section each have the shape of a curved rectangle, wherein the polarity of the adjacent permanent magnets on the shaft section alternates in each case, and wherein the shaft sections are each arranged in such a way that the polarity of the adjacent permanent magnets of neighboring shaft sections alternates.

### EXAMPLES

A rotary lifting actuator comprises a hollow cylindrical stator, a rotor arranged coaxially in the hollow cylindrical stator and a controller. The stator comprises a plurality of hollow cylindrical sections, each hollow cylindrical section comprising a plurality of coils distributed around the circumference of the hollow cylindrical section. The rotor comprises a plurality of shaft sections, each shaft section comprising a plurality of permanent magnets distributed around the circumference of the shaft section. The polarity of the permanent magnets of the rotor alternates in such a way that a checkerboard pattern is produced.

The controller is embodied to energize the coils of the hollow cylinder sections of the stator for the rotational movement of the rotor in such a way that a traveling magnetic field is generated along the hollow cylinder sections, wherein the energized coil rows along the hollow cylinder sections are at least partially energized alternately in opposite directions, and/or the controller is further embodied to energize the coils of the hollow cylinder sections of the stator for the lifting movement of the rotor in such a way that a traveling magnetic field is generated transversely with regard to the hollow cylinder sections, the energized coil rows being energized transversely with regard to the hollow cylinder sections at least partially alternately in opposite directions.

In the above rotary lifting actuator, the functional principles of the linear motor and rotary motor are combined in a single motor, which results in reduced mechanical wear. The rotary lifting actuator is also characterized by a small installation space and lower inertia. The rotary lifting actuator may be used for highly dynamic pick & place applications and rotary lifting tasks in confined spaces.

The permanent magnets of the rotary lifting actuator on the shaft section periphery of each shaft section may form a ring, wherein the permanent magnets on the shaft section periphery of the shaft section each have the shape of a curved rectangle, wherein the polarity of the adjacent permanent magnets on the shaft section alternates respectively, and wherein the shaft sections are respectively arranged in such a way that the polarity of the adjacent permanent magnets of adjacent shaft sections alternates.

This embodiment of the rotary lifting actuator allows a screwing movement of the rotor with rotations of more than 360°, at the same time having a compact structure.

In the rotary lifting actuator, the number of coils per hollow cylinder section may be larger than the number of permanent magnets per shaft section.

This embodiment of the rotary lifting actuator prevents cogging torques between the permanent magnets and the coils during the rotary movement.

The coils of the rotary lifting actuator may be operated in a three-phase alternating current mode, wherein each hollow cylinder section comprises three coils or an N-fold of the three coils distributed to its circumference, and wherein three hollow cylinder sections or an N-fold of the three hollow cylinder sections are provided in the longitudinal direction of the hollow cylinder-shaped stator.

The three-phase alternating current mode for operating the rotary lifting actuator simplifies the control of the current supply to the stator coils.

In the rotary lifting actuator, an outer circumferential surface of the rotor spanned by four permanent magnets in two shaft sections of the rotor may be covered by an inner circumferential surface of the stator spanned by the nine coils in three hollow cylinder sections of the stator.

This embodiment prevents cogging torques between the permanent magnets and the coils during the rotary lifting movement. The energizing of the circumferential surface of the stator consisting of nine coils may be identically transferred to other areas of the three hollow cylinder sections of the stator with nine coils.

The controller of the rotary lifting actuator may be embodied to energize two rows of coils in opposite directions along the hollow cylinder sections for the rotary movement of the rotor of the three adjacent hollow cylinder sections, wherein the controller is embodied to energize two rows of coils in opposite directions transverse with regard to the hollow cylinder sections for the lifting movement of the rotor in the three adjacent hollow cylinder sections.

This procedure may be used to smooth the rotary movement while saving electricity at the same time.

The controller of the rotary lifting actuator may be embodied to not energize one row of coils along the hollow cylinder sections for the rotary movement of the rotor of the three adjacent hollow cylinder sections, and not to energize one row of coils transverse with regard to the hollow cylinder sections for the lifting movement of the rotor in the three adjacent hollow cylinder sections.

This procedure may be used to smooth the lifting movement while saving electricity at the same time.

The controller of the rotary lifting actuator may be embodied to apply an alternating current individually to the coils of the hollow cylinder sections of the stator in order to set the respective phase current in the coil which is necessary for the traveling magnetic field to be generated along the hollow cylinder sections and for the traveling magnetic field to be generated transverse to the hollow cylinder sections in order to carry out a predetermined lifting and/or rotary movement of the rotor.

With this procedure, an optimized and jerk-free rotary lifting movement may be achieved.

The controller of the rotary lifting actuator may be embodied to energize hollow cylinder sections of the stator for the rotary movement of the rotor and further hollow cylinder sections of the stator for the lifting movement of the rotor in order to carry out a predetermined rotary and lifting movement of the rotor.

The separate operation of hollow cylinder sections of the stator for the rotary movement of the rotor and hollow cylinder sections of the stator for the lifting movement of the rotor simplifies the control of the current supply to the coils of the stator.

The coils of the rotary lifting actuator may be embodied in such a way that a regular grid of coil cores is embodied on an inner housing wall of the stator, with each coil core carrying a wire winding.

This embodiment allows for a compact construction of the stator in the rotary lifting actuator.

The rotary lifting actuator may include a piston rod and a cylindrical tube housing each having a bearing cap at both ends, each bearing cap having a guide ring and a wiper with a through hole, wherein the inner wall of the housing comprises the plurality of hollow cylinder sections of the stator disposed thereon, wherein the outer periphery of the piston rod comprises the plurality of shaft sections of the rotor, and wherein the piston rod extends through the guide rings and the through holes in the wipers of the two bearing caps.

This embodiment allows for a simple design of the rotary lifting actuator.

A position sensor for detecting the position of the piston rod may be provided in the cylindrical tube housing of the rotary lifting actuator.

With this embodiment, the rotary lifting movement may be controlled on the basis of a single position sensor.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A shows a schematic perspective view of a rotary lifting actuator.

FIG. 1B shows a side view of the actuator.

FIG. 1C shows a rear view of the actuator.

FIG. 1D shows a cross-section of the actuator along the C-C line in FIG. 1F.

FIG. 1E shows a longitudinal section of the actuator without a rotor along the B-B line in FIG. 1C.

FIG. 1F shows a longitudinal section of the actuator along the A-A line in FIG. 1B.

FIG. 2A shows a perspective side view of the rotary lifting actuator comprising a hollow cylindrical stator and a rotor.

FIG. 2B shows a cross-section view of the actuator.

FIGS. 3A, 3B and 3C show details of the rotary lifting actuator operating in a three-phase alternating current (AC) mode, with a quarter section of the rotary lifting actuator shown in a perspective side view in FIG. 3A, a current-time diagram in FIG. 3B and a cross section in FIG. 3C.

FIGS. 4A-4C to FIGS. 11A-11C show the operating principle of the rotary movement of the rotary lifting actuator operating in the three-phase AC mode, where a step sequence for a 90° rotation is shown with the quarter section of the rotary lifting actuator in perspective side views in FIGS. 4A to 11A, the current-time diagrams in FIGS. 4B to 11B, and the cross sections in FIGS. 4C to 11C, respectively.

FIGS. 12A, 12B and 12C show details of the rotary lifting actuator operating in a three-phase AC mode, with a quarter section of the rotary lifting actuator shown in a perspective side view in FIG. 12A, a current-time diagram in FIG. 12B and a longitudinal section in FIG. 12C.

FIGS. 13A-13C to FIGS. 20A-20C show the operating principle of the lifting movement of the rotary lifting actuator operating in the three-phase AC mode, where a step sequence for a lifting over the length of two permanent magnets is shown with the quarter section of the rotary lifting actuator in perspective side views in FIGS. 13A to 20A, the current-time diagrams in FIGS. 13B to 20B, and the cross sections in FIGS. 13C to 20C, respectively.

FIGS. 21A and 21B show details of the rotary lifting movement of the rotary lifting actuator operating in a three-phase AC mode, with a quarter section of the rotary lifting actuator shown in a perspective side view in FIG. 21A and a current-time diagram in FIG. 21B.

FIGS. 22A and 22B to FIGS. 29A and 29B show the operating principle of the rotary lifting movement of the rotary lifting actuator operating in the three-phase AC mode, where a step sequence for a rotation of 90° and a lifting over the length of two permanent magnets is shown with the quarter section of the rotary lifting actuator in perspective side views in FIGS. 22A to 29A and the current-time diagrams in FIGS. 22B to 29B, respectively.

FIG. 30A shows the coils in the three hollow cylinder sections of the stator shown in the quarter area of the rotary lifting actuator.

FIG. 30B shows the energizing of the wire windings of the rotary lifting actuator during the rotary lifting movement in FIGS. 22A and 22B to FIGS. 29A and 29B.

### DETAILED DESCRIPTION

In the following, the same reference numerals may be used for the same features. Furthermore, for reasons of clarity, it may be that not all elements are shown in each figure. Furthermore, for the sake of clarity, it may be that not every element is provided with its own reference numeral in every drawing.

An actuator for the simultaneous execution of rotary and linear movements comprises a motor that combines the functional principles of a rotary motor and a linear motor.

The rotary lifting actuator comprises a hollow cylindrical stator, which is composed of a plurality of hollow cylindrical sections, each of which is preferably annular and comprises coils distributed around the circumference. A rotor is arranged coaxially in the hollow cylindrical stator, which is composed of a plurality of shaft sections, preferably shaft rings, each shaft section comprising permanent magnets arranged distributed over the circumference of the shaft section.

The polarity of the permanent magnets of the rotor in relation to a shaft section and in relation to the composition across a plurality of shaft sections forms a checkerboard pattern. Due to the alternating magnetization of the permanent magnets on the rotor, the coils of the stator may be energized in such a way that a combined rotary and lifting movement of the rotor takes place.

To carry out the rotary movement, the coil rows of the hollow cylinder sections of the stator are at least partially energized alternately in opposite directions in order to generate a traveling magnetic field that acts on the permanent magnets arranged in a checkerboard pattern on the rotor in such a way that the rotor rotates relative to the stator.

For the lifting movement, the coils of the stator are energized transversely with regard to the hollow cylinder sections, wherein the coil rows are energized at least partially in opposite directions in order to generate a traveling magnetic field that acts upon the permanent magnets arranged in a checkerboard pattern on the rotor in such a way that the rotor moves longitudinally relative to the stator.

The superimposed phase currents in the coils of the stator for the rotary movement or for the lifting movement then allow for the rotor perform a rotary lifting movement.

By embodying a single motor as an intersection of a rotary motor and a linear motor, the installation space for the rotary lifting actuator may be reduced. By combining the functionalities of the rotary motor and of the linear motor in the single motor which may carry out a rotary movement and a lifting movement simultaneously a significantly lower inertia may additionally be achieved, which allows for dynamic applications. The combination of rotary motor and linear motor in the single motor also ensures a reduced number of components and therefore improved wear resistance.

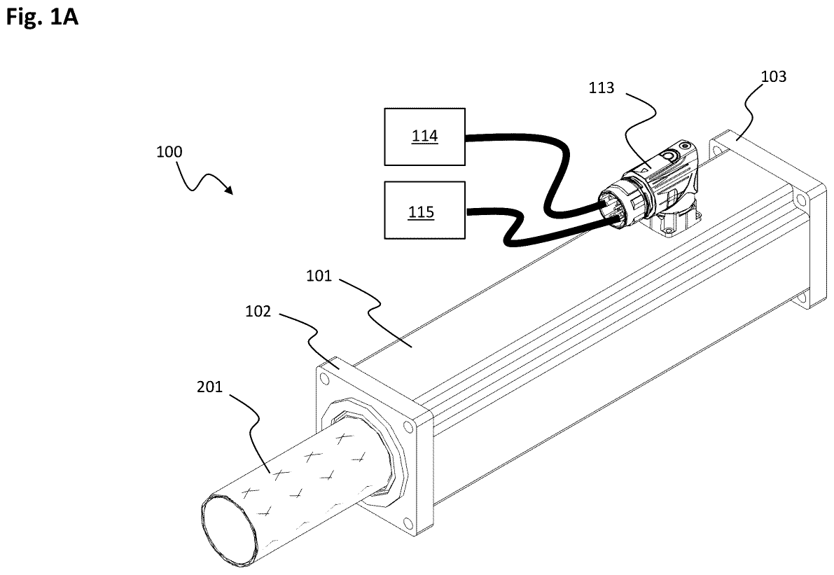

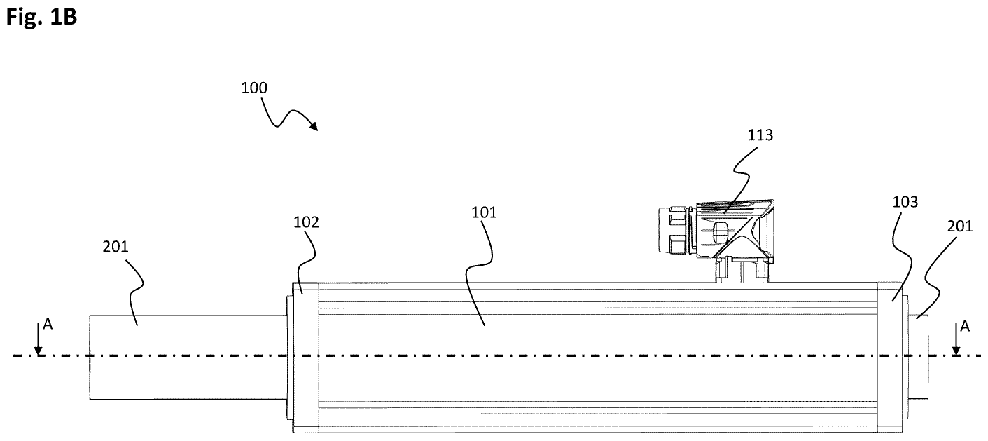

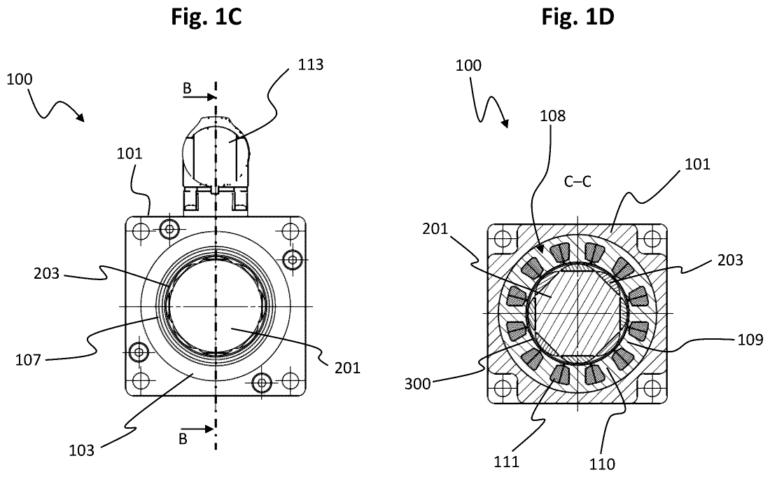

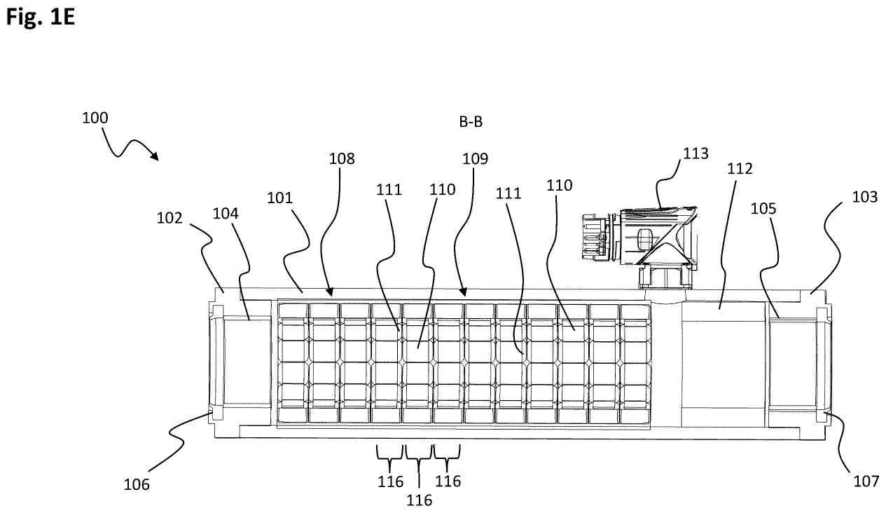

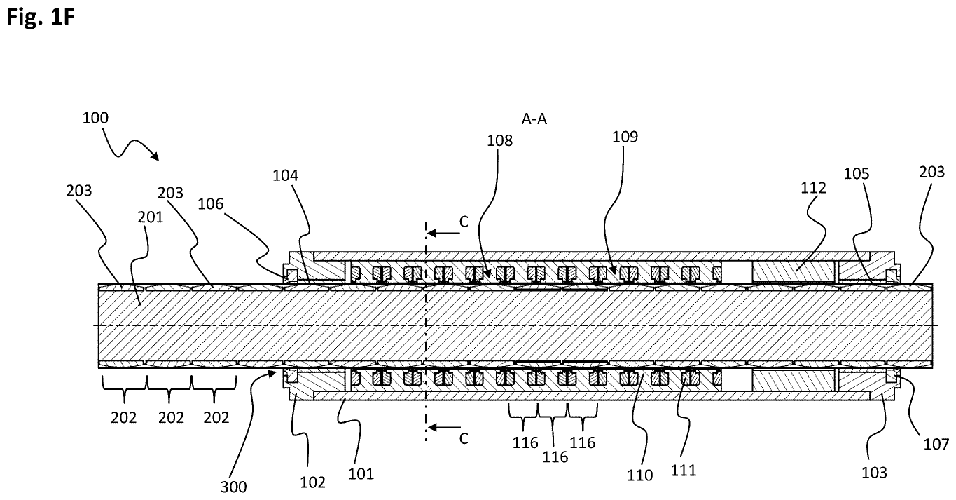

FIG. 1 shows a possible structure of such a rotary lifting actuator 100, wherein FIG. 1A shows a schematic perspective view, FIG. 1B a side view, FIG. 1C a rear view and in FIG. 1D a cross-section along the C-C line in FIG. 1F, FIG. 1E a longitudinal section through the stator without rotor along the B-B line in FIG. 1C and FIG. 1F a longitudinal section along the A-A line in FIG. 1B. FIGS. 1A to 1F are described below. For reasons of clarity, not every reference numeral is present in each of FIGS. 1A to 1F. In addition, hatching has been omitted in some of the sectional views.

The rotary lifting actuator 100 comprises a cylindrical tube housing 101, which is closed at both ends by a bearing cap. The cylindrical tube housing 101 is rectangular, as shown in the cross-section in FIG. 1D. However, a different external shape may be selected, as well.

The first bearing cap 102 and the second bearing cap 103 each comprise a guide ring and a wiper with a through hole. A shaft-shaped rotor 201 in the form of a piston rod extends through the first guide ring 104 and through the second guide ring 105 or the first through hole in the first wiper 106 and the second through hole in the second wiper 107.

As shown in FIG. 1F, the rotor 201 is made up of eighteen ring-shaped shaft sections 202, the circumferential surface of each of which is covered by eight permanent magnets 203 arranged in a row. The eight permanent magnets 203 arranged in a row are embodied as curved rectangular plates and together form a ring. A groove is preferably provided between the permanent magnets to reduce the clogging torque.

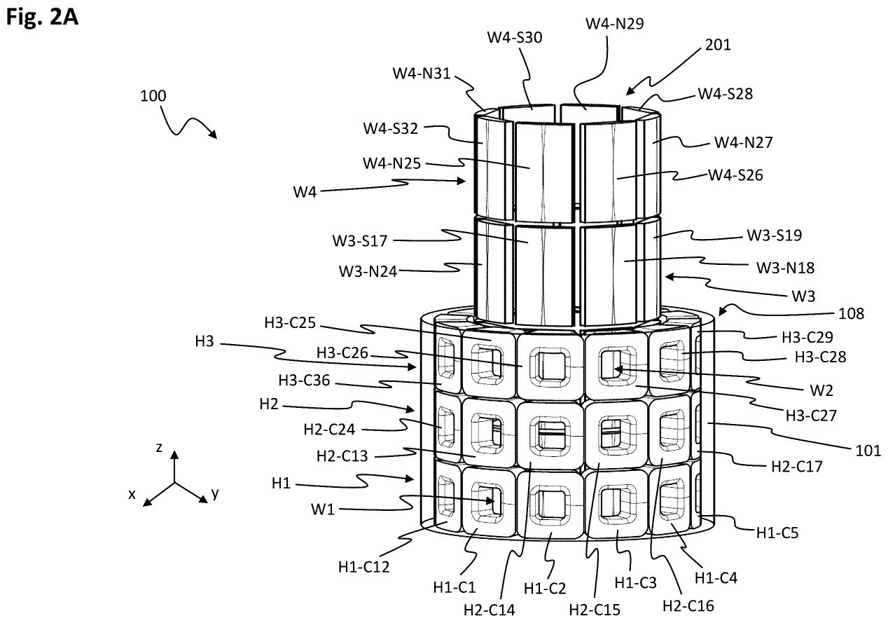

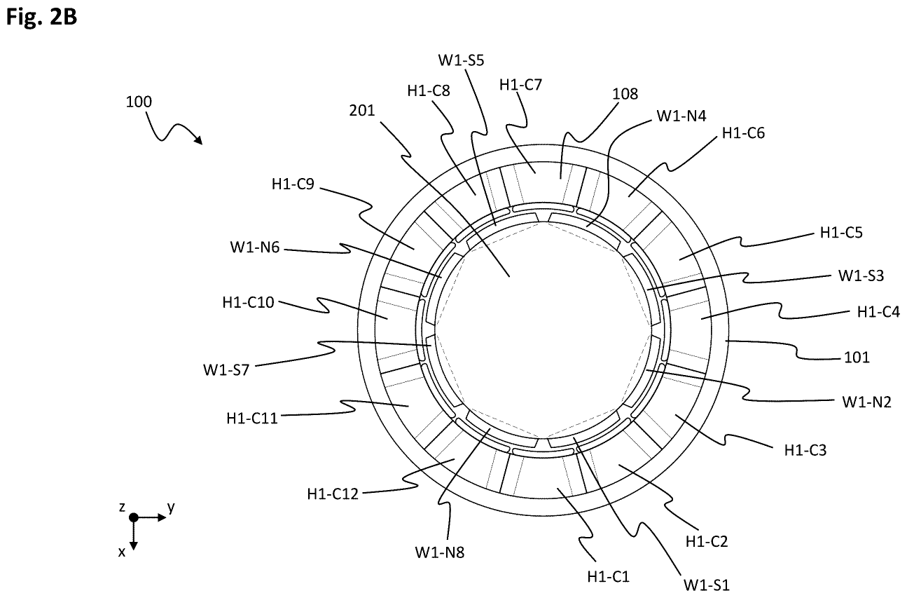

The eight permanent magnets 203 of a shaft section 202 are arranged in such a way that the polarity of adjacent permanent magnets 203 alternates. A permanent magnet 203 with a south pole is thus followed by a permanent magnet 203 with a north pole and vice versa. The eighteen shaft sections 202 of the rotor 201 are then further composed in such a way that the polarity of the adjacent permanent magnets 203 of adjacent shaft sections 202 also alternates, i.e. a permanent magnet 203 with a south pole in the adjacent shaft section 202 is followed by a permanent magnet 203 with a north pole and vice versa. The polarity of the permanent magnets 203 on the circumferential surface of the rotor 201 thus forms a checkerboard pattern when viewed as a surface. This may be seen, for example, in FIG. 2A.

As an alternative to a rectangular embodiment of the permanent magnets 203, it is also possible to use other surface shapes for the permanent magnets 203. In the embodiment shown in FIGS. 1A and 1B, the permanent magnets 203 are also arranged in a row. It is also possible to provide grooves between the permanent magnets 203, for example in the form of non-magnetic bars, in order to reduce the cogging torque. Instead of the eight permanent magnets 203 per shaft section 202, more or fewer permanent magnets 203 may be provided, wherein the permanent magnets 203 are always arranged in pairs in a ring, i.e. with one permanent magnet 203 having a south pole and one permanent magnet 203 having a north pole.

The permanent magnets 203 also do not necessarily have to cover the entire circumferential surface of the shaft section 202. It is also possible for only a circumferential area of the shaft section 202 to comprise permanent magnets 203. In this case, no full rotation of the rotor 201 is possible, but only a rotation corresponding to the circumferential angle covered by the permanent magnets 203.

In the embodiment shown in FIGS. 1A and 1B, the rotor 201 is composed of eighteen shaft sections 202. However, the number of shaft sections 202 and thus the length of the rotor 201, which is embodied as a piston rod, may be selected according to the application, in particular according to the desired lifting movement.

A hollow cylindrical stator 108 is arranged between the first bearing cap 102 and the second bearing cap 103 on the inner wall of the housing in the cylindrical tube housing 101 of the rotary lifting actuator 100. The hollow cylindrical stator 108 is composed of twelve hollow cylindrical sections 116, each hollow cylindrical section 116 comprising twelve coils 109 arranged in a row. The coils 109 each comprise a square cross-section and are curved, with the twelve coils 109 of a hollow cylindrical section 109 forming a ring when joined together.

The cylindrical tube housing 101 and the rotor 201 embodied as a piston rod are embodied in such a way that an air gap 300 remains between the coils 109 of the stator 108 on the inner wall of the cylindrical tube housing 101 and the permanent magnets 203 on the rotor 201.

In the embodiment shown in FIGS. 1A and 1B, the coils 109 comprise a ferromagnetic coil core 110, which protrudes from the inner wall of the cylindrical tube housing 101 in the shape of a tooth and around which a coil wire 111 is wound in each case. The tooth-shaped coil cores 110 form a regular grid on the inner wall of the cylindrical tube housing 101. The wire winding of the coil wire 111 is preferably multi-layered, which also makes it possible to separate individual coil wire layers from one another and to energize them separately. Instead of tooth-shaped coil cores 100, differently shaped coil cores may also be used. The coils 109 may also be air coils.

As an alternative to a square embodiment of the coils 109, it is also possible to use a different coil cross-section. Instead of the twelve coils 109 per hollow cylinder section 116, more or fewer coils 109 may also be provided.

The number of coils 109 per hollow cylinder section 116 in the cylindrical tube housing 101 is preferably larger than the number of permanent magnets 203 per shaft section 202 on the rotor 201. The permanent magnets may be composed of a plurality of permanent magnet parts of the same polarity. In the embodiment shown in FIGS. 1A and 1B, a shaft section 202 with eight permanent magnets 203 arranged in a row is arranged in a hollow cylinder section 116 with twelve coils 109 arranged in a row, resulting in a ratio of permanent magnets 203 to coils 109 of 2:3. Due to the odd ratio of the number of permanent magnets to the number of coils, cogging torques between the permanent magnets 203 and the coils 109 may be reduced during the rotary movement.

In order to avoid clogging torques during the lifting movement, the respective widths of hollow cylinder section 116 and shaft section 202 are also selected differently. In the embodiment shown in FIGS. 1A and 1B, eight shaft sections 202 of the rotor 201 correspond to the twelve hollow cylinder sections 116 of the stator 108, which results in a ratio of the permanent magnets 203 to the coils 109 of 2:3. In relation to the longitudinal alignment, the permanent magnets 203 of two shaft sections 202 cover the coils 109 of three hollow cylinder sections 116. However, it is possible to use other width and thus coverage ratios.

The number of hollow cylinder sections 116 on the inner wall of the cylindrical tube housing 101, which forms the hollow cylindrical stator 108, may be embodied to the desired application, i.e. the load torque to be moved during the rotary and lifting movement.

The coils 109 of the rotary lifting actuator 100 are preferably operated in a three-phase AC mode, wherein each hollow cylinder section 116 comprises three coils 109 or an N-fold of the three coils 109, and wherein three hollow cylinder sections 116 or an N-fold of the three hollow cylinder sections 116 are provided. As an alternative to a three-phase alternating current operation, it is also possible to carry out a two-phase or single-phase alternating current operation of the coils 109.

In principle, for a rotary movement of the rotor 201, the coils 109 of the hollow cylinder sections 116 of the stator 108 are to be energized in such a way that a traveling magnetic field is generated along the hollow cylinder sections 116, the energized coils 109 being energized at least partially alternately in opposite directions along the hollow cylinder sections 116.

For a lifting movement of the rotor 201, the coils 109 of the hollow cylinder sections 116 of the stator 108 are to be energized in such a way that a traveling magnetic field is generated transversely with regard to the hollow cylinder sections 116, with the energization transversely with regard to the hollow cylinder sections 116 being at least in part carried out alternately in opposite directions.

For a combined rotary lifting movement, the rotary movement is then superimposed with the lifting movement in relation to the energization of the coils 109, resulting in a three-dimensional flux, i.e. a three-dimensional traveling magnetic field.

Between the hollow cylindrical stator 108 and the second bearing cap 103, as shown in FIG. 1F, a ring-shaped position sensor 112 is also provided on the inner wall of the cylindrical tube housing 101, with which the position of the rotor 201 in relation to the cylindrical tube housing 101 may be determined.

The cylindrical tube housing 101 also comprises a connection 113 for electrical and data connection to a controller 114 and an energy supply 115, as schematically indicated in FIG. 1A. The controller 114 regulates the energization of the coils 109 connected to the energy supply 115 in the rotary lifting actuator 100 on the basis of position signals from the position sensor 112 in order to carry out a desired rotary movement, lifting movement or rotary lifting movement.

The controller 114 may be embodied to apply alternating current individually to the coils 109 of the hollow cylinder sections 116 of the stator 108 in order to set the phase current in the respective coil 109 which is necessary for the traveling magnetic field to be produced along the hollow cylinder sections 116 and for the traveling magnetic field to be produced transversely with regard to the hollow cylinder sections 116 in order to carry out a predetermined lifting and/or rotary movement of the rotor 201.

However, the controller 114 may also be embodied to energize hollow cylinder sections 116 of the stator 108 for the rotational movement of the rotor 201 and further hollow cylinder sections 116 of the stator 108 for the lifting movement of the rotor 201 in order to carry out a predetermined rotary and lifting movement of the rotor 201.

FIGS. 2A and 2B schematically show a section of the hollow cylindrical stator 108 and of the rotor 201 in the rotary lifting actuator 100, with FIG. 2A showing the section in a perspective side view and FIG. 2B showing a cross-section through the section. FIGS. 2A and 2B also show a Cartesian coordinate system for orientation.

As FIG. 2A shows, the hollow cylindrical stator 108 and the shaft-shaped rotor 201 are aligned axially symmetrically with regard to the z-direction. The cross-section shown in FIG. 2B lies in the plane spanned by the x-direction and y-direction. Of the square coils, only the wire windings without coil cores are shown in FIGS. 2A and 2B. The cylindrical tube housing is also shown in the area of the coils.

In FIG. 2A, the four shaft sections are labeled from bottom to top as first shaft section W1, second shaft section W2, third shaft section W3 and fourth shaft section W4. The polarity of the eight permanent magnets in each shaft section, which form a ring, alternates in such a way that a permanent magnet with a south pole is followed by a permanent magnet with a north pole and vice versa.

Furthermore, the four shaft sections are composed in such a way that a permanent magnet with a south pole in one shaft section is followed by a permanent magnet with a north pole in a neighboring shaft section and vice versa.

Viewed counterclockwise from the x-direction in FIG. 2A, the lower first shaft section W1 comprises a first south pole permanent magnet W1-S1, a second north pole permanent magnet W1-N2, a third south pole permanent magnet W1-S3, a fourth north pole permanent magnet W1-N4, a fifth south pole permanent magnet W1-S5, a sixth north pole permanent magnet W1-N6, a seventh south pole permanent magnet W1-S7 and an eighth north pole permanent magnet W1-N8. The first shaft section W1 is shown in cross-section in FIG. 2B.

The second shaft section W2 placed onto the lower first shaft section W1 comprises a ninth north pole permanent magnet W2-N9, a tenth south pole permanent magnet W2-S10, an eleventh north pole permanent magnet W2-N11, a twelfth south pole permanent magnet W2-S12, a thirteenth north pole permanent magnet W2-N13, a fourteenth south pole permanent magnet W2-S14, a fifteenth north pole permanent magnet W2-N15 and a sixteenth south pole permanent magnet W2-S16.

The third shaft section W3 placed onto the second shaft section W2 has a seventeenth south pole permanent magnet W3-S17, an eighteenth north pole permanent magnet W3-N18, a nineteenth south pole permanent magnet W3-S19, a twentieth north pole permanent magnet W3-N20, a twenty-first south pole permanent magnet W3-S21, a twenty-second north pole permanent magnet W3-N22, a twenty-third south pole permanent magnet W3-S23 and a twenty-fourth north pole permanent magnet W3-N24.

Viewed counterclockwise from the x-direction in FIG. 2A, the fourth shaft section W4 placed onto the third shaft section W3 comprises has a twenty-fifth north pole permanent magnet W4-N25, a twenty-sixth south pole permanent magnet W4-S26, a twenty-seventh north pole permanent magnet W4-N27, a twenty-eighth south pole permanent magnet W4-S28, a twenty-ninth north pole permanent magnet W4-N29, a thirtieth south pole permanent magnet W4-S30, a thirty-first north pole permanent magnet W4-N31 and a thirty-second south pole permanent magnet W4-S32.

Viewed counterclockwise from the x-direction in FIG. 2A, the lower first hollow cylinder section H1 comprises, a first coil H1-C1, a second coil H1-C2, a third coil H1-C3, a fourth coil H1-C4, a fifth coil H1-C5, a sixth coil H1-C6, a seventh coil H1-C7, an eighth coil H1-C8, a ninth coil H1-C9, a tenth coil H1-C10, an eleventh coil H1-C11 and a twelfth coil H1-C12. The first hollow cylinder section H1 is shown in cross-section in FIG. 2B.

Viewed counterclockwise from the x-direction in FIG. 2A, the second hollow cylinder section H2 placed onto the lower first hollow cylinder section H1 comprises, in a strung-together manner, a thirteenth coil H2-C13, a fourteenth coil H2-C14, a fifteenth coil H2-C15, a sixteenth coil H2-C16, a seventeenth coil H2-C17, an eighteenth coil H2-C18, a nineteenth coil H2-C19, a twentieth coil H2-C20, a twenty-first coil H2-C21, a twenty-second coil H2-C22, a twenty-third coil H2-C23 and a twenty-fourth coil H2-C24.

Viewed counterclockwise from the x-direction in FIG. 2A, the third hollow cylinder section H3 placed onto the second hollow cylinder section H2 comprises, in a strung-together manner, a twenty-fifth coil H2-C25, a twenty-sixth coil H3-C26, a twenty-seventh coil H3-C27, a twenty-eighth coil H3-C28, a twenty-ninth coil H3-C29, a thirtieth coil H3-C30, a thirty-first coil H3-C31, a thirty-second coil H3-C32, a thirty-third coil H3-C33, a thirty-fourth coil H2-C24, a thirty-fifth coil H3-C35 and a thirty-sixth coil H3-C36.

The perspective side view in FIG. 2A shows only a part of the above-mentioned permanent magnets of the four shaft sections of the rotor and a part of the above-mentioned coils of the three hollow cylinder sections of the stator.

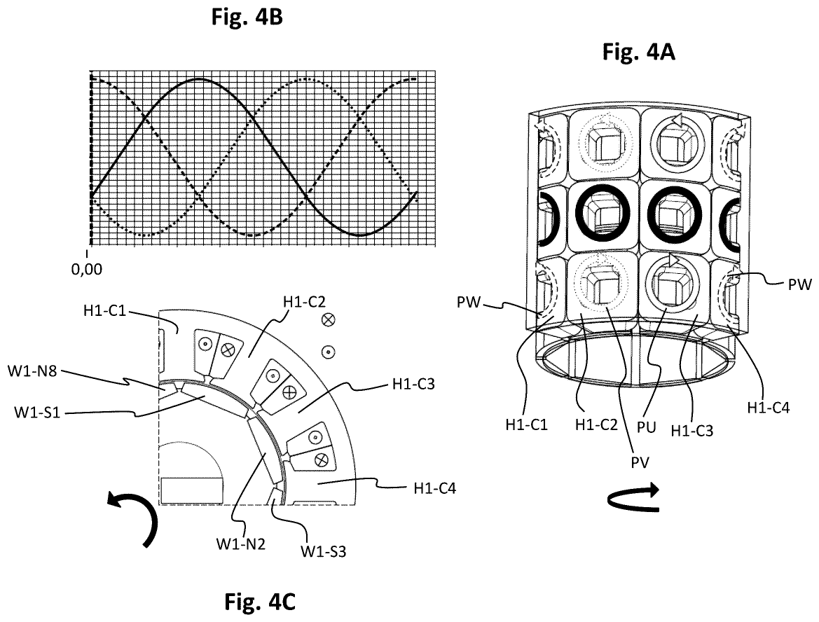

The functional principle of the rotary lifting actuator 100 is further described in connection with FIGS. 4A-4C to FIGS. 11A-11C, FIGS. 13A-13C to FIGS. 20A-20C, and FIGS. 22A and 22B to FIGS. 29A and 29B using a section of FIG. 2A, which corresponds to a 90° angle of the stator 108 and of the rotor 201 when viewed in the z-direction. The coils of the rotary lifting actuator 100 are operated in the three-phase alternating current mode, which is why only the coils in the quarter range are considered in the further illustration.

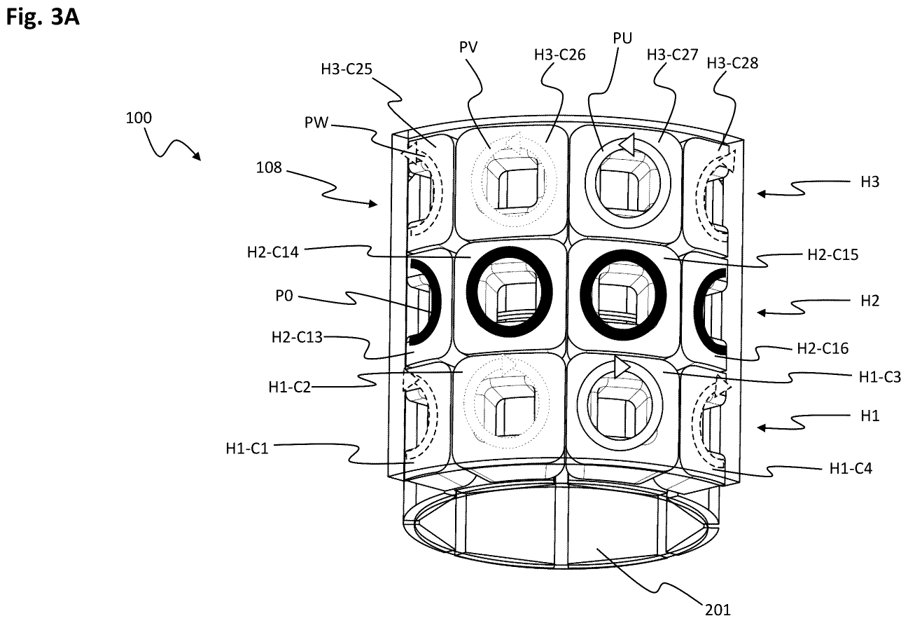

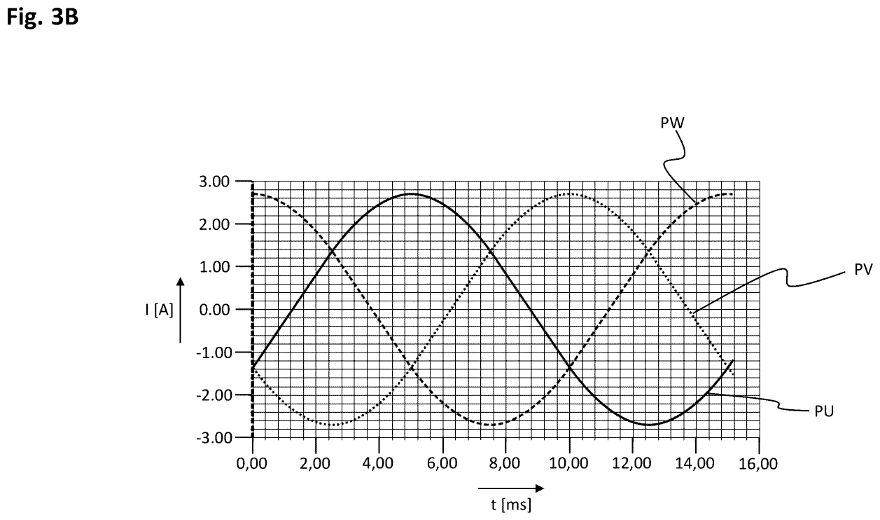

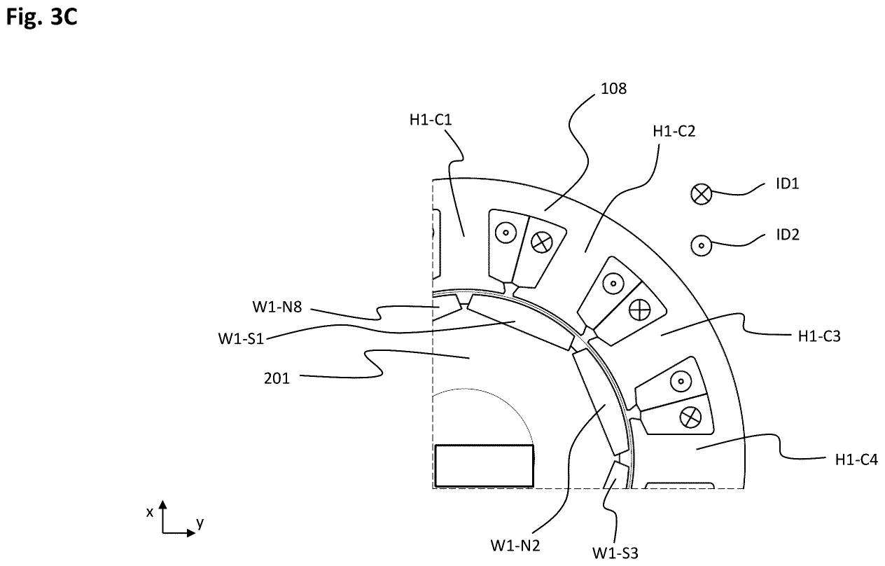

For reasons of better illustration, details of FIGS. 4A-4C are shown separately in the three FIGS. 3A, 3B and 3C, where the description of FIGS. 4A-4C to FIGS. 11A-11C is given with reference to FIGS. 3A-3C, without the need for a separate reference in each case.

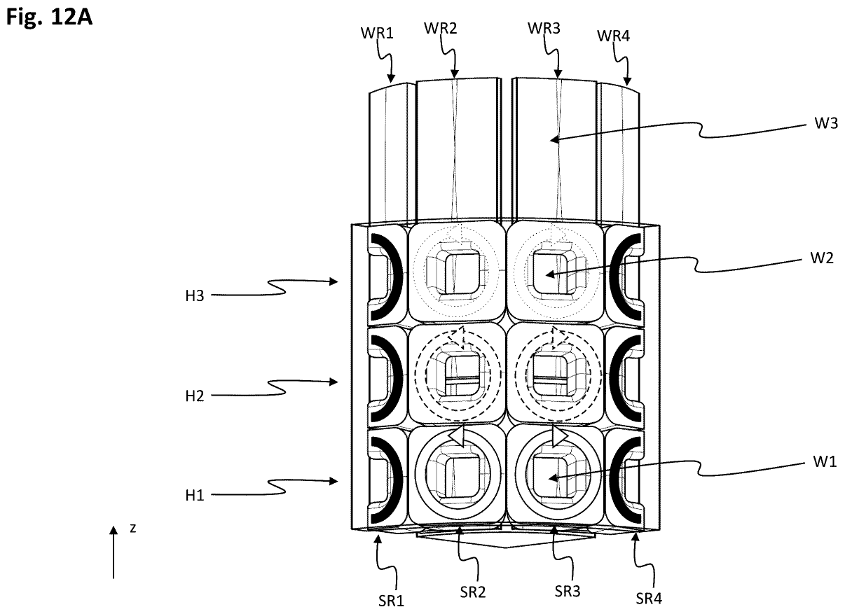

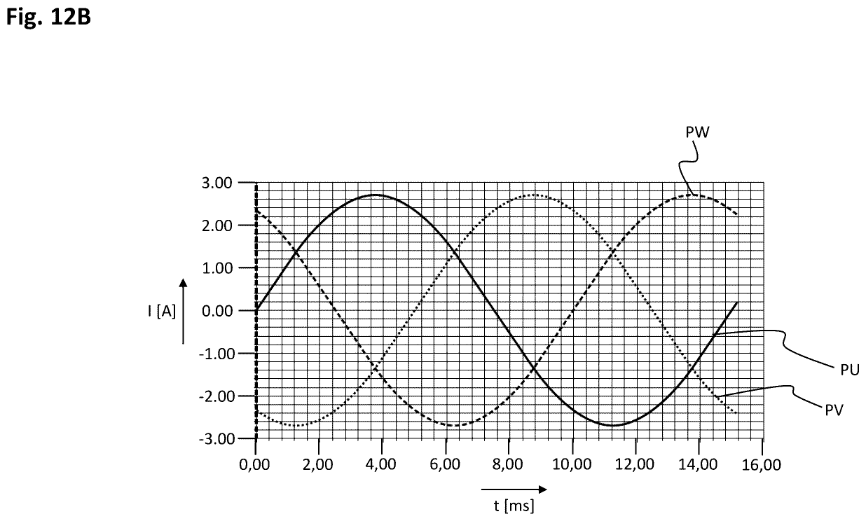

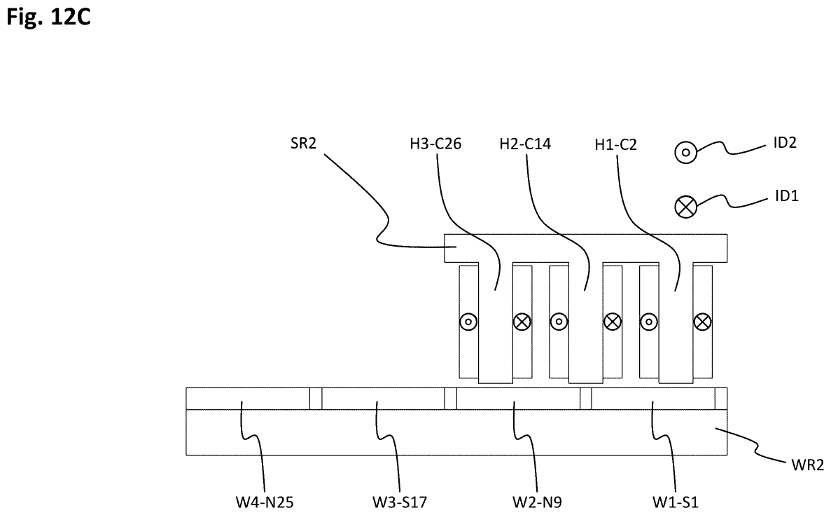

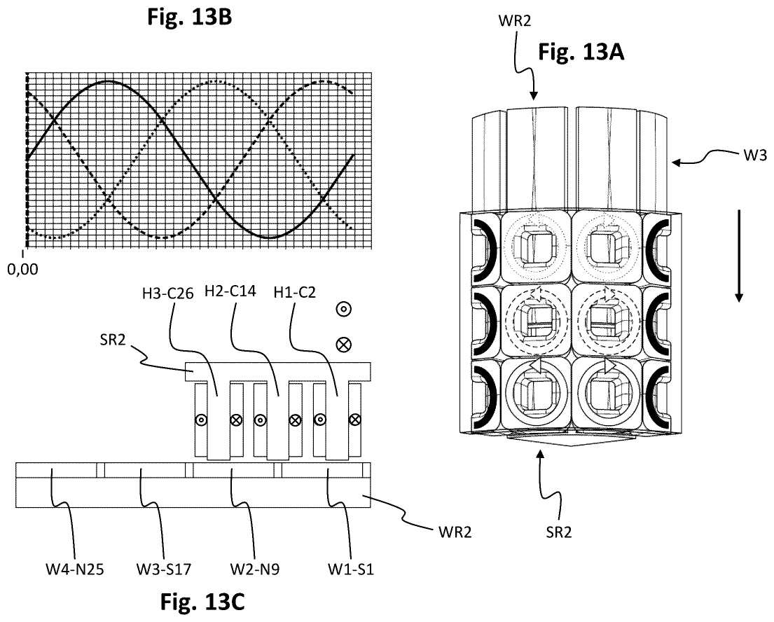

For reasons of better illustration, details of FIGS. 13A, 13B and 13C are shown separately in the three FIGS. 12A, 12B and 12C, where the description of FIGS. 13A-13C to FIGS. 20A-20C is given with reference to FIGS. 12A-12C, without the need for a separate reference in each case.

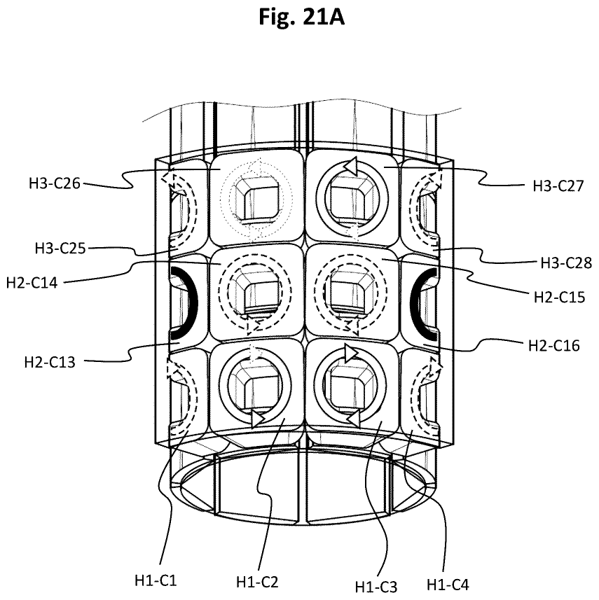

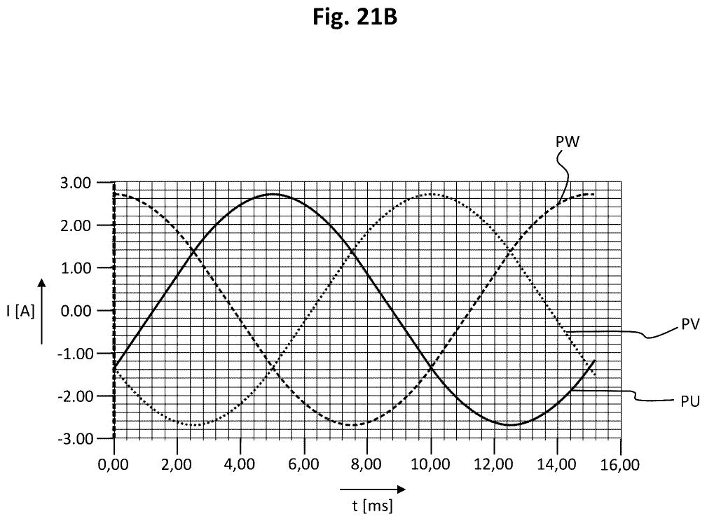

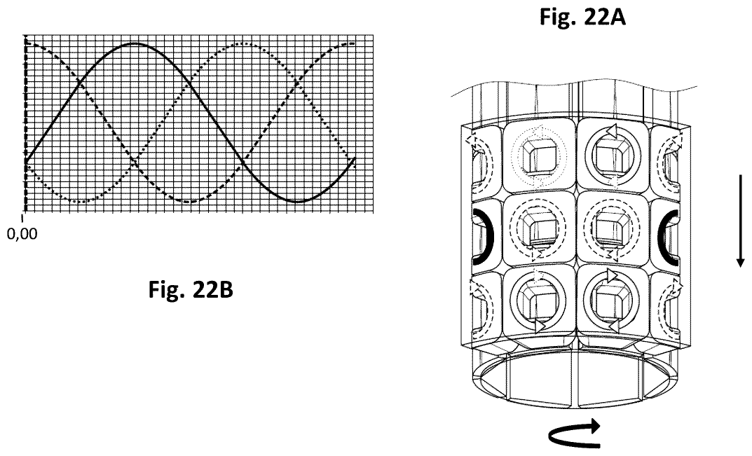

For reasons of better illustration, details of FIGS. 22A and 22B are shown separately in the two FIGS. 21A and 21B, where the description of FIGS. 22A and 22B to FIGS. 29A and 29B is given with reference to FIGS. 21A-21B, without the need for a separate reference in each case.

Accordingly, FIG. 3A shows the section with two shaft sections of the rotor 201, which are arranged in three hollow cylinder sections of the stator. In the embodiment shown in FIG. 3A, an outer circumferential surface of the rotor 201 spanned by four permanent magnets in two shaft sections of the rotor 201 is covered by an inner circumferential surface of the stator 108 spanned by nine coils in the three hollow cylinder sections of the stator 108.

Three coils along each hollow cylinder section or three coils transverse with regard to the hollow cylinder sections are operated with the three individual alternating currents of the same frequency, i.e. a first alternating current PU, a second alternating current PV and a third alternating current PW, which are shifted by 120° in relation to each other in terms of the phase angle.

The energization of the circumferential surface of the quarter area of the stator consisting of nine coils is transferred identically to the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections.

In the following, the functional principle of a rotary movement of the rotary lifting actuator is described with reference to FIGS. 4A-4C to FIGS. 11A-11C, the functional principle of a lifting movement of the rotary lifting actuator is explained with reference to FIGS. 13A-13C to FIGS. 20A-20C, and the functional principle of a rotary lifting movement of the rotary lifting actuator is described with reference to FIGS. 22A and 22B to FIGS. 29A and 29B.

The description is based on a quarter section of the section of the rotary lifting actuator 100 shown in FIG. 2A comprising nine coils in three hollow cylinder sections of the stator.

Viewed counterclockwise from the x-direction, the second coil H1-C2, the third coil H1-C3 and the first half of the fourth coil H1-C4 are shown lined up from the lower first hollow cylinder section H1.

Viewed counterclockwise from the x-direction, the second half of the thirteenth coil H2-C13, the fourteenth coil H2-C14, the fifteenth coil H2-C15 and the first half of the sixteenth coil H2-C16 are shown lined up from the second hollow cylinder section H2 placed onto the lower first hollow cylinder section H1.

Viewed counterclockwise from the x-direction, the first half of the twenty-fifth coil H3-C25, the twenty-sixth coil H3-C26, the twenty-seventh coil H3-C27 and the second half of the twenty-eighth coil H3-C28 are shown lined up from the third hollow cylinder section H3 placed on the second hollow cylinder section H2.

FIG. 3B shows the course of the first alternating current PU, the second alternating current PV and the third alternating current PW in a current-time diagram, where the different alternating currents are marked by different patterns. The actual current values of the three coils, which are operated in three-phase alternating current mode along each hollow cylinder section, are entered with a dashed line for the angle of rotation shown in the step-by-step diagram.

FIG. 3C shows a cross-section of the quarter area of the lower first hollow cylinder section H1. For better illustration, a larger area is shown in the x and y directions, respectively, so that the quarter area is completely visible. Starting from the x-direction, the second half of the first coil H1-C1, the second coil H1-C2, the third coil H1-C3 and the first half of the fourth coil H1-C4 are shown in a row. The wire windings are labeled by the pattern of the associated alternating current, with ID1 indicating the direction of the electrical current from the observer into the plane and ID2 indicating the direction of the electrical current from the plane to the observer. The position of the shaft sections of the rotor is also shown for the rotational angle shown in the step-by-step-by-step diagram.

FIGS. 4A-4C to FIGS. 11A-11C show a 90° rotation of the rotor in eight steps.

In each of the eight step-by-step diagrams, the course of the first alternating current PU, the second alternating current PV and the third alternating current PW are shown in the current-time diagram.

Furthermore, in each of the eight step-by-step images, the quarter area from the section of the rotary lifting actuator shown in FIG. 3A with nine coils in three hollow cylinder sections of the stator is shown in perspective alignment.

The coils that are energized, the alternating current assigned to the respective coils and the current direction of the alternating current are indicated for the respective angle of rotation shown in the step-by-step-by-step diagram. When a coil is energized, the coil is marked with a ring having an arrow, wherein the ring bears the pattern of the assigned alternating current and an arrow in the ring indicates the direction of the current. Coils having only a black ring without an arrow indicate coils that are not energized. The position of the shaft sections of the rotor is also shown for the rotational angle shown in the step-by-step diagram. An arrow in the 2D view (corresponding to the depiction in FIG. 3C) and the 3D view (corresponding to the depiction in FIG. 3A) symbolizes that a counterclockwise rotation of the rotor 201 is described in FIGS. 4A-4C to FIGS. 11A-11C.

In the 90° rotation of the rotor shown in eight steps in FIGS. 4A-4C to FIGS. 11A-11C, the rotor is aligned with respect to the stator in such a way that the first shaft section W1 and the second shaft section W2 are covered by the inner circumferential surface of the stator spanned in the first hollow cylinder section H1, the second hollow cylinder section H2 and the third hollow cylinder section H1 of the stator. In FIGS. 4A-4C to FIGS. 11A-11C, the rotation is counterclockwise (in relation to the arrow shown).

The coils of the first hollow cylinder section H1 lie opposite to the permanent magnets of the first shaft section W1 and the coils of the third hollow cylinder section H3 lie opposite to the permanent magnets of the second shaft section W2. Since the polarity of the adjacent permanent magnets of the first shaft section W1 and the second shaft section W2 alternate, i.e. a permanent magnet with a south pole is connected to a permanent magnet with a north pole and vice versa, the traveling magnetic field generated in the coils of the hollow cylinder sections by the three-phase alternating current acts in opposite directions.

In order to cause a joint counterclockwise rotary movement, the alternating current in the coils of the first hollow cylinder section H1 and the coils of the third hollow cylinder section H3 circulates in the opposite direction. The alternating current flows through the square wire windings of the coils of the first hollow cylinder section H1 in a clockwise direction, as indicated by the direction of the arrow in the ring in the perspective view of the quarter section in FIGS. 4A-4C to FIGS. 11A-11C.

In the coils of the third hollow cylinder section H3, on the other hand, the alternating current flows counterclockwise through the square wire windings, as shown by the arrow in the ring in the perspective view of the quarter section in FIGS. 4A-4C to FIGS. 11A-11C.

In the coils of the second hollow cylinder section H2, the lower half covers the permanent magnets of the first shaft section W1 and the upper half covers the permanent magnets of the second shaft section W2. Due to the different polarity of the adjacent permanent magnets of the first shaft section W1 and the second shaft section W2, the rotational effects on the first shaft section W1 and the second shaft section W2, which are caused by a traveling magnetic field generated in the coils of the second hollow cylinder section H2 when a three-phase alternating current is applied, cancel each other out. The coils of the second hollow cylinder section H2 are therefore not energized, as indicated by the rings without arrows in the perspective view of the quarter section in FIGS. 4A-4C to FIGS. 11A-11C.

In FIGS. 4A-4C to FIGS. 11A-11C, the quarter region of the lower first hollow cylinder section H1 corresponding to FIG. 3C is also shown in cross-section for each of the eight step images.

FIGS. 4A, 4B and 4C show the starting point of the rotary movement.

The shaft-shaped rotor is located in the hollow cylindrical stator in relation to the quarter region in a position in which, as the cross-section shows, the first south pole permanent magnet W1-S1 and the second north pole permanent magnet W1-N2 of the lower first shaft section W1 are opposite to the second half of the first coil H1-C1, the second coil H1-C2, the third coil H1-C3 and the first half of the fourth coil H1-C4 in the lower first hollow cylindrical section H1.

In the current-time diagram, which shows the course of the first alternating current PU, the second alternating current PV and the third alternating current PW, the three coils, which are operated along each hollow cylinder section in three-phase alternating current mode, are energized with the current values of the first alternating current PU, the second alternating current PV and the third alternating current PW at time 0.00, as indicated by the dashed line.

The perspective view of the quarter section further shows that in the lower first hollow cylinder section H1, the second half of the first coil H1-C1 is operated by the third alternating current PW, the second coil H1-C2 by the second alternating current PV, the third coil H1-C3 is operated by the first alternating current PU and the first half of the fourth coil H1-C4 is again operated by the third alternating current PW, with the alternating current circulating clockwise in the wire windings of the coils of the first hollow cylinder section H1, as indicated by the arrow in the rings.

The coils of the second hollow cylinder section H2 are not energized.

In the third hollow cylinder section H3, one half of the twenty-fifth coil H3-C25 is energized with the third alternating current PW, the twenty-sixth coil H3-C26 by the second alternating current PV, the twenty-seventh coil H3-C27 by the first alternating current PU and one half of the twenty-eighth coil H3-C28 again by the third alternating current PW. The alternating current circulates counterclockwise in the wire windings of the coils of the third hollow cylinder section H3, as indicated by the arrow in the rings.

The energization of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 4A, 4B and 4C.

The current supply to the coils of the quarter section, as shown in FIGS. 4A, 4B and 4C, remains the same during the entire rotary movement. Only the current values of the first alternating current PU, the second alternating current PV and the third alternating current PW change in the individual coils in order to generate the traveling magnetic field.

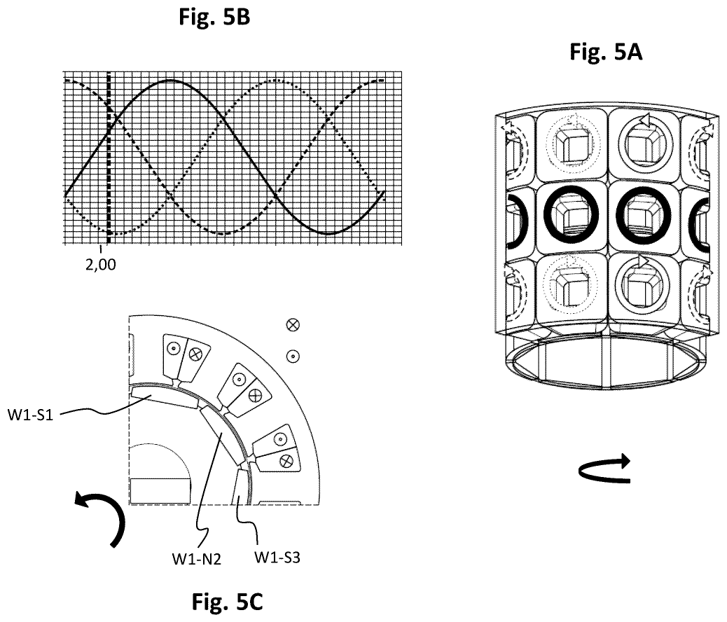

FIGS. 5A, 5B and 5C show the rotary lifting actuator 100 after a first rotational step of the rotor by 12°.

As the cross-section shows, the entire first south pole permanent magnet W1-S1 is no longer located in the quarter area of the first hollow cylinder section H1, but a section of the third south pole permanent magnet W1-S3 is.

In the current-time diagram, the three coils that are operated along each hollow cylinder section in three-phase AC mode are energized with the current values of the first AC PU, the second AC PV and the third AC PW at time 2.00, as indicated by the dashed line.

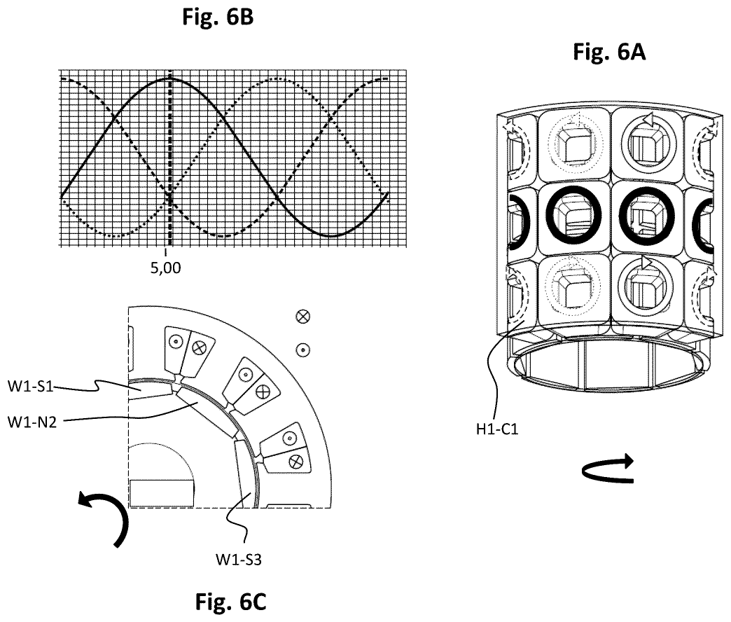

FIGS. 6A, 6B and 6C show the rotary lifting actuator 100 after a second rotational step of the rotor by a further 18° to 30°.

As the cross-section shows, a further area of the first south pole permanent magnet W1-S1 is no longer in the quarter area of the first hollow cylinder section H1, but a further section of the third south pole permanent magnet W1-S3 is.

In the current-time diagram, the three coils that are operated along each hollow cylinder section in three-phase AC mode are energized with the current values of the first AC PU, the second AC PV and the third AC PW at time 5.00, as indicated by the dashed line.

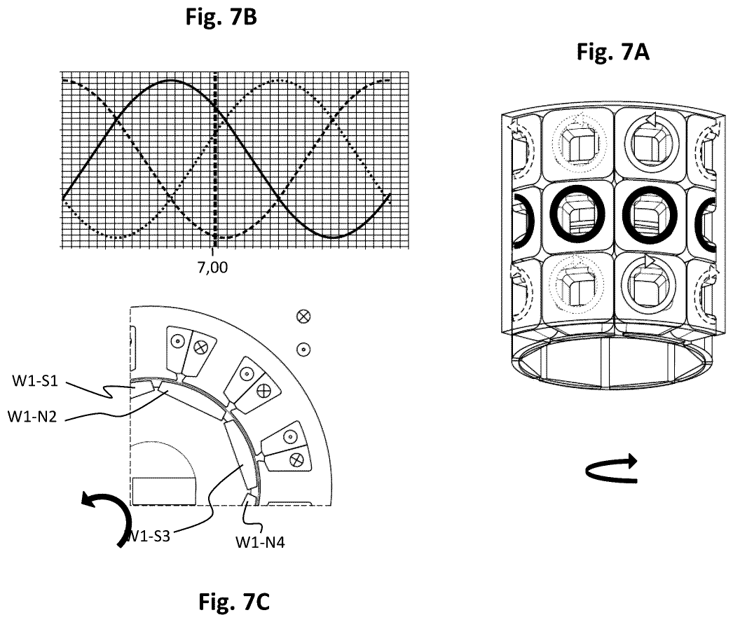

FIGS. 7A, 7B and 7C show the rotary lifting actuator 100 after a third rotational step of the rotor by a further 12° to 42°.

As the cross-section shows, the first south pole permanent magnet W1-S1 is no longer in the quarter area of the first hollow cylindrical section H1, but the third south pole permanent magnet W1-S3 is. The shaft-shaped rotor is located in the hollow cylindrical stator in relation to the quarter area in a position in which the second north pole permanent magnet W1-N2 and the third south pole permanent magnet W1-S3 of the lower first shaft section W1 are opposite to the second half of the first coil H1-C1, the second coil H1-C2, the third coil H1-C3 and the first half of the fourth coil H1-C4 in the lower first hollow cylindrical section H1.

In the current-time diagram, the three coils that are operated along each hollow cylinder section in three-phase AC mode are energized with the current values of the first AC PU, the second AC PV and the third AC PW at time 7.00, as indicated by the dashed line.

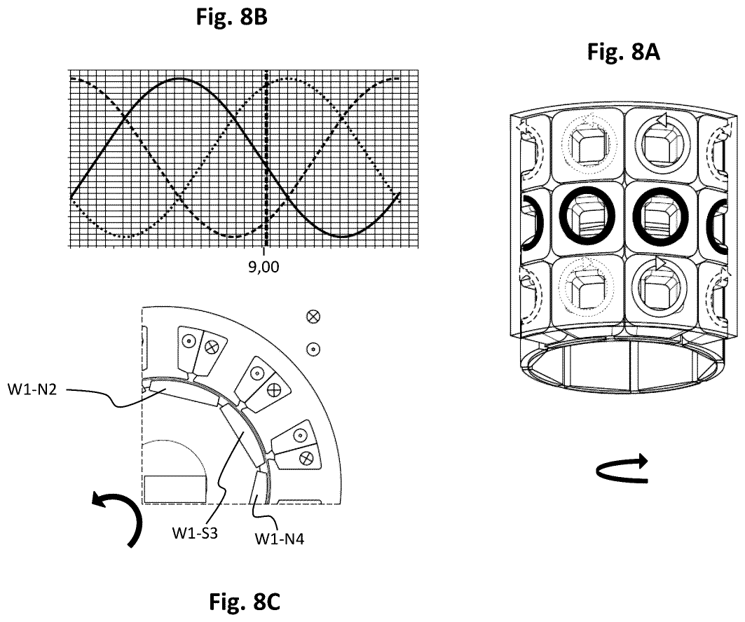

FIGS. 8A, 8B and 8C show the rotary lifting actuator 100 after a fourth rotational step of the rotor by a further 12° to 54°.

As the cross-section shows, the entire second north pole permanent magnet W1-N2 is no longer located in the quarter area of the first hollow cylinder section H1, but a section of the fourth north pole permanent magnet W1-N4 is.

In the current-time diagram, the three coils that are operated along each hollow cylinder section in three-phase AC mode are energized with the current values of the first AC PU, the second AC PV and the third AC PW at time 9.00, as indicated by the dashed line.

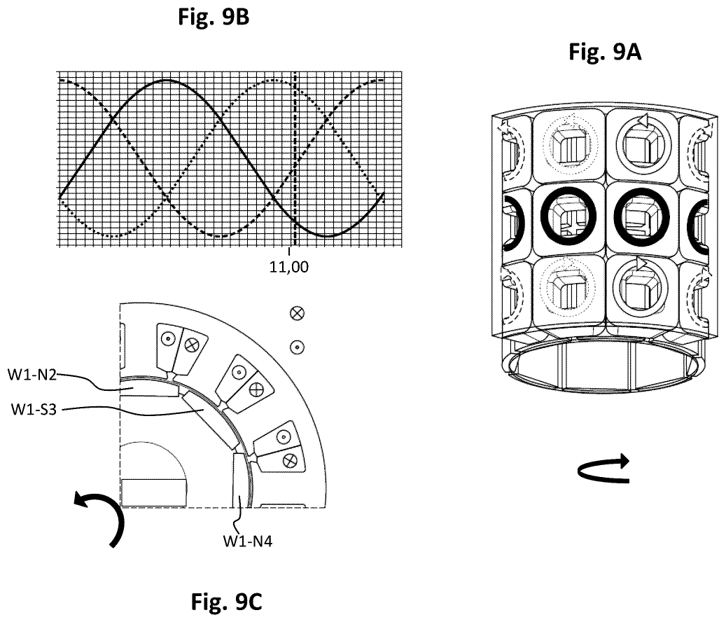

FIGS. 9A, 9B and 9C show the rotary lifting actuator 100 after a fifth rotational step of the rotor by a further 12° to 66°.

As the cross-section shows, a further area of the second north pole permanent magnet W1-N2 is no longer in the quarter area of the first hollow cylinder section H1, but a further section of the fourth north pole permanent magnet W1-N4 is.

In the current-time diagram, the three coils that are operated along each hollow cylinder section in three-phase AC mode are energized with the current values of the first AC PU, the second AC PV and the third AC PW at time 11.00, as indicated by the dashed line.

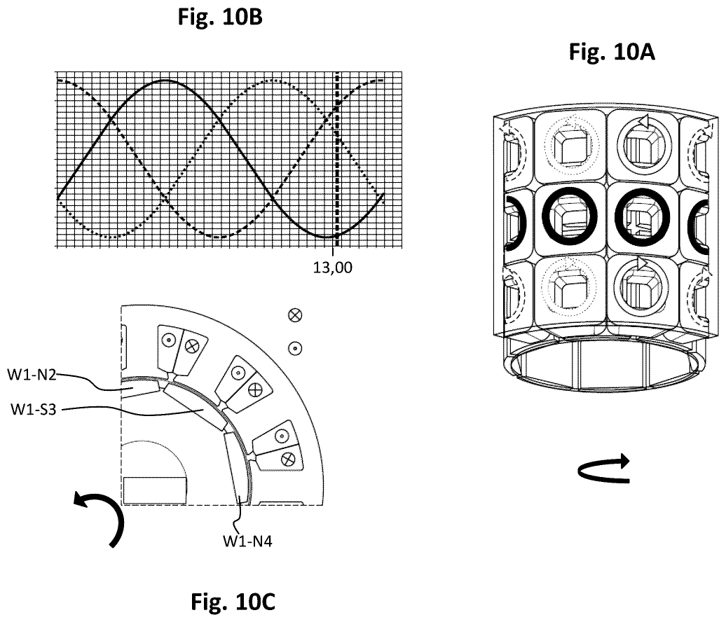

FIGS. 10A, 10B and 10C show the rotary lifting actuator 100 after a sixth rotational step of the rotor by a further 12° to 78°.

As the cross-section shows, a further area of the second north pole permanent magnet W1-N2 is no longer in the quarter area of the first hollow cylinder section H1, but a further section of the fourth north pole permanent magnet W1-N4 is.

In the current-time diagram, the three coils that are operated along each hollow cylinder section in three-phase AC mode are energized with the current values of the first AC PU, the second AC PV and the third AC PW at time 13.00, as indicated by the dashed line.

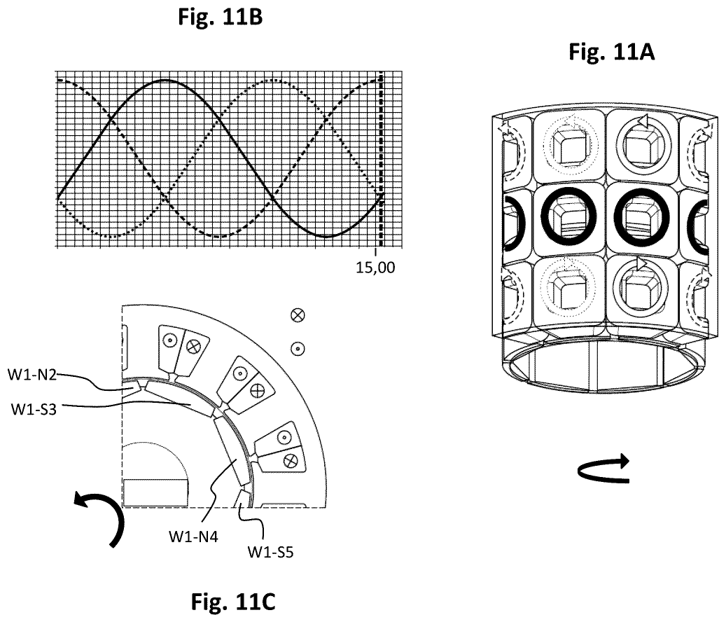

FIGS. 11A, 11B and 11C show the rotary lifting actuator 100 after a final seventh rotational step of the rotor by a further 12° to 90°.

As the cross-section shows, the second north pole permanent magnet W1-N2 is no longer in the quarter area of the first hollow cylindrical section H1, but the fourth north pole permanent magnet W1-N4 is. The shaft-shaped rotor is located in the hollow cylindrical stator in relation to the quarter area in a position in which the third south pole permanent magnet W1-S3 and the fourth north pole permanent magnet W1-N4 of the lower first shaft section W1 are opposite to the second half of the first coil H1-C1, the second coil H1-C2, the third coil H1-C3 and the first half of the fourth coil H1-C4 in the lower first hollow cylindrical section H1.

In the current-time diagram, the three coils that are operated along each hollow cylinder section in three-phase AC mode are energized with the current values of the first AC PU, the second AC PV and the third AC PW at time 15.00, as indicated by the dashed line.

Starting from the energization of the coils of the quarter section, as shown in FIGS. 11A, 11B and 11C, a further rotation of the rotor by 90° may be carried out, as shown in FIGS. 4A-4C to FIGS. 11A-11C.

FIGS. 13A-13C to FIGS. 20A-20C show a lifting of the rotor over the length of two permanent magnets in eight steps.

In FIG. 12A, the quarter section from the section of the linear-rotary actuator 100 shown in FIG. 2A with nine coils in three hollow cylinder sections of the stator and three shaft sections of the rotor is shown in perspective orientation. The depiction shown in FIG. 12A is also shown in each of the eight step-by-step diagrams in FIGS. 13A to 20A. An arrow is used to symbolize that a lifting movement of the rotor 201 is described in FIGS. 13A-13C to FIGS. 20A-20C.

In the lifting of the rotor over the length of two permanent magnets shown in FIGS. 13A-13C to FIGS. 20A-20C in eight steps, the rotor is aligned in relation to the stator in such a way that the first shaft section W1 and the second shaft section W2 are covered by the inner circumferential surface of the stator spanned in the first hollow cylinder section H1, the second hollow cylinder section H2 and the third hollow cylinder section H3 of the stator. The third shaft section W3 and the fourth shaft section W4, shown in FIG. 12C and FIG. 13C, protrude beyond the hollow cylinder sections when viewed in the z-direction.

A first row of coils SR1 formed by the first coil H1-C1 of the first hollow cylinder section H1, the thirteenth coil H2-C13 of the second hollow cylinder section H2 and the twenty-fifth coil H3-C25 of the third hollow cylinder section H3 in each case lies in the first half of a row of coils SR1 formed by the eighth north pole permanent magnet W1-N8 of the first shaft section W1, the sixteenth south pole permanent magnet W2-S16 of the second shaft section W2, the twenty-fourth north pole permanent magnet W3-N24 of the third shaft section W3 and the thirty-second south pole permanent magnet W4-S32 of the fourth shaft section W2 during the lifting movement of the rotor, the twenty-fourth north pole permanent magnet W3-N24 of the third wave section W3 and the thirty-second south pole permanent magnet W4-S32 of the fourth wave section W4 and in each case the second half of a row of permanent magnets WR1 formed from the first south pole permanent magnet W1-S1 of the first wave section W1, the ninth north pole permanent magnet W2-N9 of the second shaft section W2, the seventeenth south pole permanent magnet W3-S17 of the third shaft section W3 and the twenty-fifth north pole permanent magnet W4-N25 of the fourth shaft section W4.

A second row of coils SR2 formed by the second coil H1-C2 of the first hollow cylinder section H1, the fourteenth coil H2-C14 of the second hollow cylinder section H2 and the twenty-sixth coil H3-C26 of the third hollow cylinder section H3 is in contact with the first south pole permanent magnet W1-S1 of the first shaft section W1 during the lifting movement of the rotor, the ninth north pole permanent magnet W2-N9 of the second shaft section W2, the seventeenth south pole permanent magnet W3-S17 of the third shaft section W3 and the twenty-fifth north pole permanent magnet W4-N25 of the fourth shaft section W4 opposite to the second permanent magnet row WR2 formed by the first south pole permanent magnet W1-S1 of the first shaft section W1, the ninth north pole permanent magnet W2-N9 of the second shaft section W2, the seventeenth south pole permanent magnet W3-S17 of the third shaft section W3 and the twenty-fifth north pole permanent magnet W4-N25 of the fourth shaft section W4.

A third row of coils SR3, formed by the third coil H1-C3 of the first hollow cylinder section H1, the fifteenth coil H2-C15 of the second hollow cylinder section H2 and the twenty-seventh coil H3-C27 of the third hollow cylinder section H3, is located in the lifting movement of the rotor of a rotor consisting of the second north pole permanent magnet W1-N2 of the first shaft section W1, the tenth south pole permanent magnet W2-S10 of the second shaft section W2, the eighteenth north pole permanent magnet W3-N18 of the third shaft section W3 and the twenty-sixth south pole permanent magnet W4-S26 of the fourth shaft section W4.

A fourth row of coils SR4 formed by the fourth coil H1-C4 of the first hollow cylinder section H1, the sixteenth coil H2-C16 of the second hollow cylinder section H2 and the twenty-eighth coil H3-C28 of the third hollow cylinder section H3 lies in each case in the first half of the first row of coils SR4 formed by the second north pole permanent magnet W1-N2 of the first shaft section W1, the tenth south pole permanent magnet W2-S10 of the second shaft section W2, the eighteenth north pole permanent magnet W3-N18 of the third shaft section W3 and the twenty-sixth south pole permanent magnet W4-S26 of the fourth shaft section W4 during the lifting movement of the rotor, the eighteenth north pole permanent magnet W3-N18 of the third shaft section W3 and the twenty-sixth south pole permanent magnet W4-S26 of the fourth shaft section W4 and in each case the second half of a third permanent magnet row WR3 formed from the third south pole permanent magnet W1-S3 of the first shaft section W1, the eleventh north pole permanent magnet W2-N11 of the second shaft section W2, the nineteenth south pole permanent magnet W3-S19 of the third shaft section W3 and the twenty-seventh north pole permanent magnet W4-N27 of the fourth shaft section W4.

As the polarities of the adjacent permanent magnets in the second row of permanent magnets WR2 and of the third row of permanent magnets WR3 alternate, i.e. a permanent magnet with a south pole is connected to a permanent magnet with a north pole and vice versa, the traveling magnetic fields generated by the three-phase alternating current in the second row of coils SR2 and the third row of coils SR3 act in opposite directions transverse to the hollow cylinder sections.

In order to cause a joint lifting movement against the z-direction, the alternating current in the second coil row SR2 and the third coil row SR3 circulates in the opposite direction. The alternating current flows through the square wire winding of the coils in the second coil row SR2 counterclockwise, as indicated by the direction of the arrow in the ring in the perspective view of the quarter section in FIGS. 13A-13C to FIGS. 20A-20C.

In the coils of the third coil row SR3, the current flows clockwise through the square wire winding, as shown by the arrow in the ring in the perspective view of the quarter section in FIGS. 13A-13C to FIGS. 20A-20C.

In the coils of the first coil series SR1, the first half covers the permanent magnets of the first permanent magnet series WR1 and the second half covers the permanent magnets of the second permanent magnet series WR2. Furthermore, in the coils of the fourth coil series SR4, the first half covers the permanent magnets of the third permanent magnet series WR3 and the second half covers the permanent magnets of the fourth permanent magnet series WR4.

Due to the different polarities of the adjacent permanent magnets in the shaft sections, the lifting effects caused by a traveling magnetic field generated when a three-phase alternating current is applied in the coils of the first row of coils SR1 or the fourth row of coils SR4 cancel each other out. The coils of the first row of coils SR1 and the fourth row of coils SR4 are therefore not energized, as indicated by the rings without arrows in the perspective view of the quarter section in FIGS. 13A to 20A.

FIG. 12B shows the course of the first alternating current PU, the second alternating current PV and the third alternating current PW in a current-time diagram, wherein the different alternating currents are marked with different patterns. In the respective step-by-step diagram corresponding to FIGS. 13A-13C to FIGS. 20A-20C, the current values of the three coils, which are operated in three-phase alternating current mode across the three hollow cylinder sections, are entered for the respective lifting shown in the step-by-step diagram with a dashed line.

In FIG. 12C and additionally in FIGS. 13C to 20C, the second row of coils SR2 and the second row of permanent magnets WR2 are also shown in cross-section in rotated form for each of the eight step images.

The second row of coils SR2 consists of the second coil H1-C2 of the first hollow cylinder section H1, the fourteenth coil H2-C14 of the second hollow cylinder section H2 and the twenty-sixth coil H3-C26 of the third hollow cylinder section H3. The second row of permanent magnets WR2 comprises, starting from the left, the first south pole permanent magnet W1-S1 of the first shaft section W1, the ninth north pole permanent magnet W2-N9 of the second shaft section W2, the seventeenth south pole permanent magnet W3-S17 of the third shaft section W3 and the twenty-fifth north pole permanent magnet W4-N25 of the fourth shaft section W4.

The wire windings of the coils are marked with the pattern of the associated alternating current, with ID1 indicating the direction of the electrical current from the observer into the plane and ID2 indicating the direction of the electrical current from the plane to the observer. The position of the permanent magnet row WR2 in relation to the second coil row SR2 is also shown for the respective lifting shown in the step-by-step diagram.

FIGS. 13A, 13B and 13C show the starting point of the lifting movement.

The shaft-shaped rotor is located in the hollow cylindrical stator in a position in which, as the cross-section shows, the first south pole permanent magnet W1-S1 of the first shaft section W1 and the ninth north pole permanent magnet W2-N9 of the second shaft section W2 are opposite to the second coil H1-C2 of the first hollow cylindrical section H1, the fourteenth coil H2-C14 of the second hollow cylinder section H2 and the twenty-sixth coil H3-C26 of the third hollow cylinder section H3.

In the current-time diagram, which shows the course of the first alternating current PU, the second alternating current PV and the third alternating current PW, the three coils, which are operated along each hollow cylinder section in three-phase alternating current mode, are energized with the current values of the first alternating current PU, the second alternating current PV and the third alternating current PW at time 0.00, as indicated by the dashed line.

The perspective view of the quarter section further shows that in the first hollow cylinder section H1, the second coil H1-C2 and the third coil H1-C3 are operated with the first alternating current PU, in the second hollow cylinder section H2 the fourteenth coil H2-C14 and the fifteenth coil H2-C15 are operated with the third alternating current PW and in the third hollow cylinder section H3 the twenty-sixth coil H3-C26 and the twenty-seventh coil H3-C27 are operated with the second alternating current PV, wherein the alternating current in the wire windings of the second coil row SR2 formed by the second coil H1-C2, the fourteenth coil H2-C14 and the twenty-sixth coil H3-C26 rotates counterclockwise and in the wire windings of the third coil row SR3 formed by the third coil H1-C3, the fifteenth coil H2-C15 and the twenty-seventh coil H3-C27 rotates clockwise, as indicated by the arrow in the rings.

The current direction in the wire windings of the second coil series SR2 is marked in cross-section with a dot indicating the current flow out of the drawing plane in the first halves of the coils and a cross indicating the current flow into the drawing plane in the second halves of the coils.

For reasons of simplification, the second row of coils SR2 is shifted relative to the second row of permanent magnets WR2 in the illustration in FIGS. 13A-13C to FIGS. 20A-20C. According to the description, however, the rotor moves in a lifting movement relative to the stator. This means that the second row of permanent magnets WR2 moves with respect to the stationary second row of coils SR2.

The coils of the first row of coils SR1 and of the fourth row of coils SR4 are not energized. The energization of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 13A, 13B and 13C.

The current supply to the coils of the quarter section, as shown in FIGS. 13A, 13B and 13C, remains the same during the entire lifting movement. Only the current values of the first alternating current PU, the second alternating current PV and the third alternating current PW change in the individual coils in order to generate the traveling magnetic field.

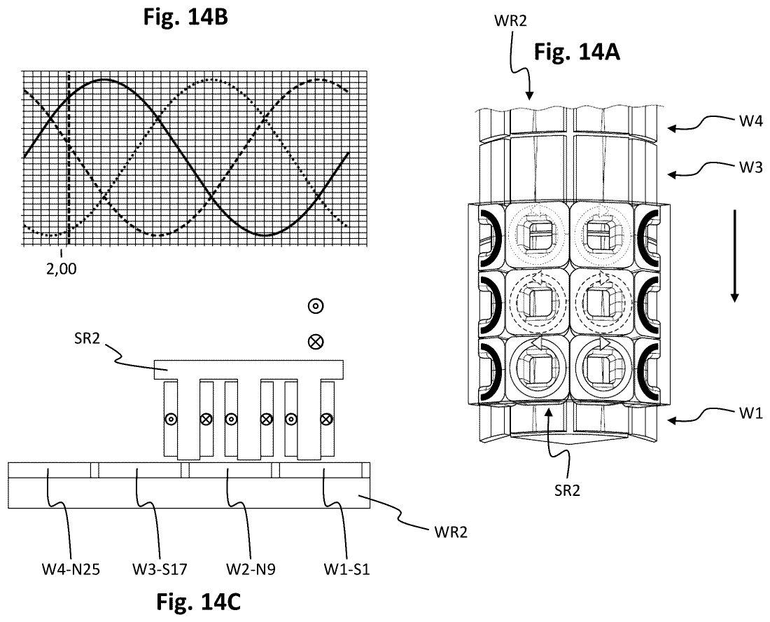

FIGS. 14A, 14B and 14C show the rotary lifting actuator 100 after a first lifting step with a lifting that is 0.27 times the pole pitch. Pole pitch is the distance between two permanent magnets, measured from center to center.

As the cross-section shows, the entire first south pole permanent magnet W1-S1 of the second permanent magnet row WR2 is no longer located in the area of the second coil row SR2, but a section of the seventeenth south pole permanent magnet W3-S17 of the second permanent magnet row WR2 is.

The first shaft section W1 of the rotor moves out of the section of the stator with the three hollow cylinder sections against the z-direction, as shown in the perspective view and illustrated by an arrow, while the third shaft section W3 of the rotor moves into the section of the stator with the three hollow cylinder sections against the z-direction.

In the current-time diagram, the three coils of the second coil series SR2 and the third coil series SR3, which are each operated transversely with regard to the hollow cylinder sections in three-phase AC mode, are energized with the current values of the first AC current PU, the second AC current PV and the third AC current PW at time 2.00, as indicated by the dashed line.

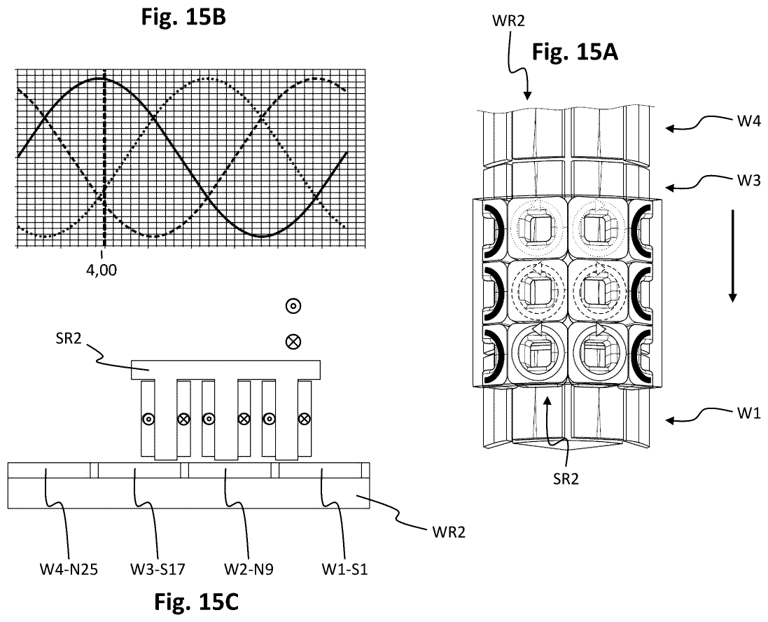

FIGS. 15A, 15B and 15C show the rotary lifting actuator 100 after a second lifting step of the rotor with a lifting of 0.27 times the pole pitch to a total lifting of 0.54 times the length of a permanent magnet.

As the cross-section shows, a further section of the first south pole permanent magnet W1-S1 of the second permanent magnet row WR2 is located outside of the area of the second coil row SR2, but a further section of the seventeenth south pole permanent magnet W3-S17 of the second permanent magnet row WR2 is located in the area of the second coil row SR2.

As the perspective view shows, the first shaft section W1 of the rotor has moved further out of the section of the stator with the three hollow cylinder sections, while the third shaft section W3 of the rotor has moved further into the section of the stator with the three hollow cylinder sections.

In the current-time diagram, the three coils of the second coil series SR2 and the third coil series SR3, which are each operated transversely with regard to the hollow cylinder sections in three-phase AC mode, are energized with the current values of the first AC current PU, the second AC current PV and the third AC current UW at time 4.00, as indicated by the dashed line.

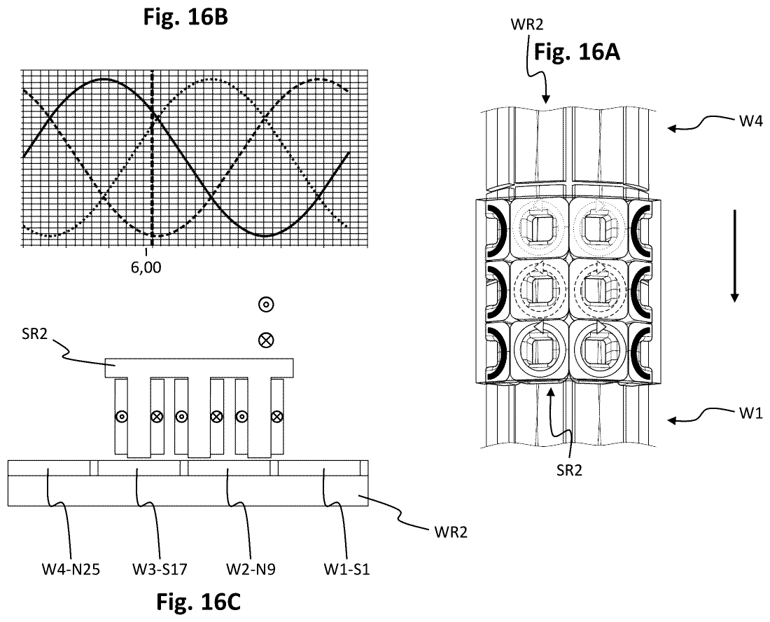

FIGS. 16A, 16B and 16C show the rotary lifting actuator 100 after a third lifting step of the rotor with a lifting of 0.27 times the pole pitch to a total lifting of 0.81 times the length of a permanent magnet.

As the cross-section shows, the larger part of the first south pole permanent magnet W1-S1 of the second permanent magnet row WR2 is located outside of the area of the second coil row SR2, but a further section of the seventeenth south pole permanent magnet W3-S17 of the second permanent magnet row WR2 is located in the area of the second coil row SR2.

As the perspective view shows, the first shaft section W1 of the rotor protrudes largely beyond the section of the stator with the three hollow cylinder sections, while the third shaft section W3 is now almost completely in the area of the section of the stator with the three hollow cylinder sections.

In the current-time diagram, the three coils of the second coil series SR2 and the third coil series SR3, which are each operated transversely with regard to the hollow cylinder sections in three-phase AC mode, are energized with the current values of the first AC current PU, the second AC current PV and the third AC current PW at time 6.00, as indicated by the dashed line.

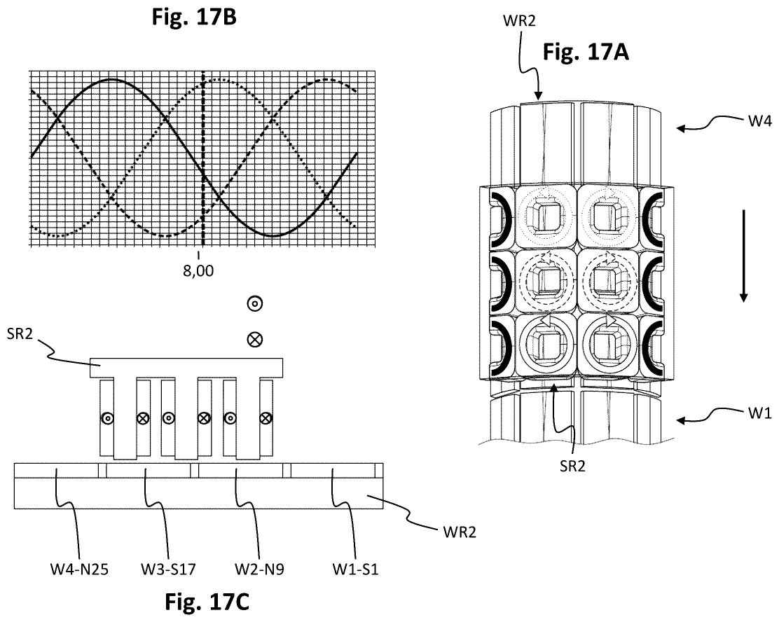

FIGS. 17A, 17B and 17C show the rotary lifting actuator 100 after a fourth lifting step of the rotor with a lifting of 0.27 times the pole pitch to a total lifting of 1.08 times the length of a permanent magnet.

As the cross-section shows, the first south pole permanent magnet W1-S1 of the second permanent magnet row WR2 is located outside of the area of the second coil row SR2 and the seventeenth south pole permanent magnet W3-S17 of the second permanent magnet row WR2 is located in the area of the second coil row SR2.

As the perspective view shows, the first shaft section W1 of the rotor protrudes beyond the section of the stator with the three hollow cylinder sections, while the third shaft section W3 of the rotor is covered by the area of the section of the stator with the three hollow cylinder sections.

In the current-time diagram, the three coils of the second coil series SR2 and the third coil series SR3, which are each operated transversely with regard to the hollow cylinder sections in three-phase alternating current mode, are energized with the current values of the first alternating current PU, the second alternating current PV and the third alternating current PW at time 8.00, as shown by the dashed line.

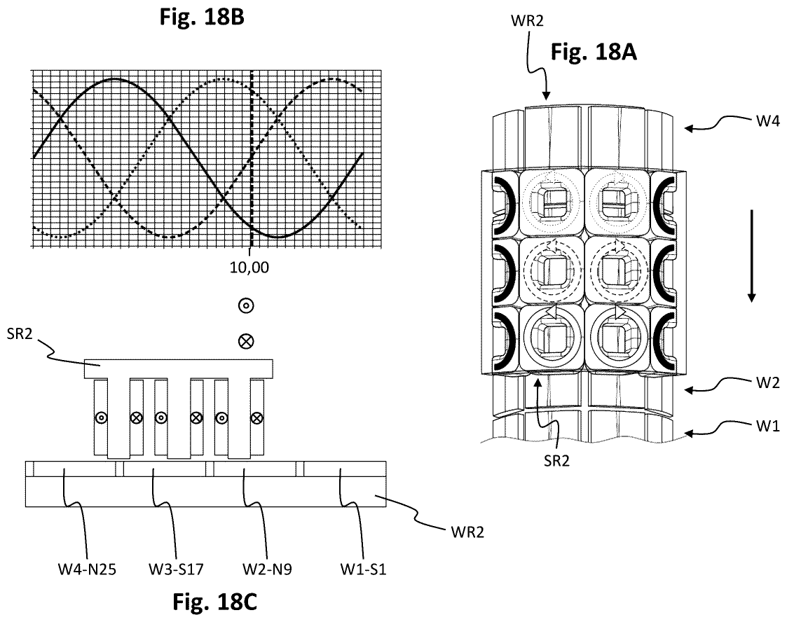

FIGS. 18A, 18B and 18C show the rotary lifting actuator 100 after a fifth lifting step of the rotor by a lifting of 0.27 times the pole pitch to a total lifting of 1.35 times the length of a permanent magnet.

As the cross-section shows, a section of the ninth north pole permanent magnet W2-N9 of the second permanent magnet series WR2 is now also located in the area outside of the second coil row SR2, but a section of the twenty-fifth north pole permanent magnet W4-N25 of the second permanent magnet series WR2 is located in the area inside the second coil row SR2.

In addition to the first shaft section W1 of the rotor, the second shaft section W2 of the rotor, as shown in the perspective view, also protrudes from the cut-out of the rotor with the three hollow cylinder sections in the opposite direction to the z-direction, while the fourth shaft section W4 of the stator is pushed into the cut-out of the rotor with the three hollow cylinder sections in the opposite direction to the z-direction.

In the current-time diagram, the three coils of the second coil series SR2 and the third coil series SR3, which are each operated transversely with regard to the hollow cylinder sections in three-phase AC mode, are energized with the current values of the first AC current PU, the second AC current PV and the third AC current PW at time 10.00, as indicated by the dashed line.

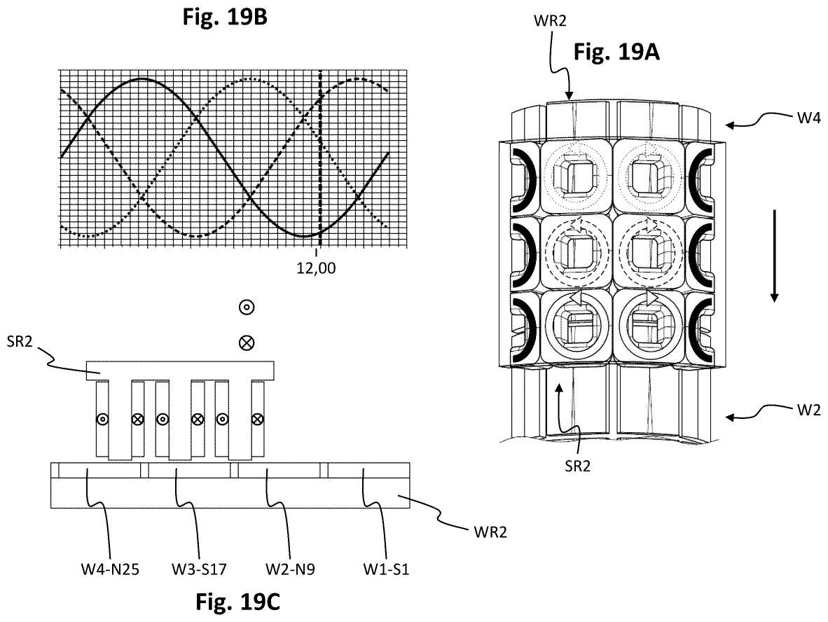

FIGS. 19A, 19B and 19C show the rotary lifting actuator 100 after a sixth lifting step of the rotor with a lifting of 0.27 times the pole pitch to a total lifting of 1.62 times the length of a permanent magnet.

As the cross-section shows, a further section of the ninth north pole permanent magnet W2-N9 of the second permanent magnet series WR2 is located in the area outside of the second coil row SR2, but a further section of the twenty-fifth north pole permanent magnet W4-N25 of the second permanent magnet series WR2 is located in the area inside of the second coil row SR2.

The second shaft section W2 of the rotor protrudes further out of the area of the rotor with the three hollow cylinder sections, as shown in the perspective view, while the fourth shaft section W4 extends further into the cut-out of the rotor with the three hollow cylinder sections.

In the current-time diagram, the three coils of the second coil series SR2 and the third coil series SR3, which are operated transversely with regard to the hollow cylinder sections in three-phase alternating current mode, are energized with the current values of the first alternating current PU, the second alternating current PV and the third alternating current PW at the time 12.00, as shown by the dashed line.

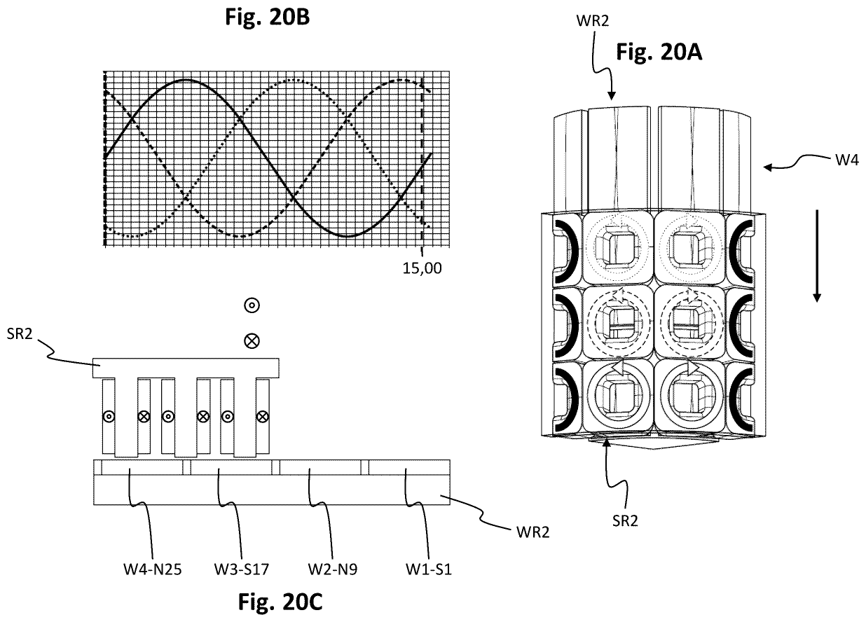

FIGS. 20A, 20B and 20C show the rotary lifting actuator 100 after a final seventh lifting step of the rotor with a lifting of 0.38 times the pole pitch to a total lifting of 2 times that of a permanent magnet.

As the cross-section shows, the first south pole permanent magnet W1-S1 and the ninth north pole permanent magnet W2-N9 of the second permanent magnet row WR2 are located in front of the area of the second coil row SR2. The second coil row SR2 now covers the seventeenth south pole permanent magnet W3-S17 and the twenty-fifth north pole permanent magnet W4-N25 of the second permanent magnet row WR2.

As the perspective view shows, the first shaft section W1 and the second shaft section W2 of the rotor protrude beyond the section of the stator with the three hollow cylinder sections, while the third shaft section W3 and the fourth shaft section W4 are located in the area of the section of the stator with the three hollow cylinder sections.

In the current-time diagram, the three coils of the second coil series SR2 and the third coil series SR3, which are each operated transversely with regard to the hollow cylinder sections in three-phase AC mode, are energized with the current values of the first AC current PU, the second AC current PV and the third AC current PW at time 15.00, as indicated by the dashed line.

Starting from the energization of the coils of the quarter section, as shown in FIGS. 20A, 20B and 20C, a further lifting of the rotor may be carried out over the length of two permanent magnets, as shown in FIGS. 13A-13C to FIG. 20A-20C.

In eight step-by-step diagrams, FIGS. 22A and 22B to FIGS. 29A and 29B show a combination of the rotation of the rotor through 90°, which is shown in FIGS. 4A-4C to FIGS. 11A-11C, with the lifting of the rotor over the length of two permanent magnets, which is shown in FIGS. 13A-13C to FIGS. 20A-20C.

FIG. 21A shows a perspective view of the quarter section of the rotary lifting actuator 100 shown in FIG. 2A with nine coils in three hollow cylinder sections of the stator and three shaft sections of the rotor. The illustration then corresponds to the illustration in FIGS. 3A and 12A. The depiction according to FIG. 21A is also shown in each of the eight step-by-step diagrams according to FIGS. 22A and 22B to FIGS. 29A and 29B. With the aid of a first arrow and of a second arrow, it is symbolized that a combined rotation-lifting movement of the rotor 201 is described in FIGS. 22A and 22B to FIGS. 29A and 29B.

For the rotary lifting movement shown in the step-by-step diagram, the quarter area shows which coils are energized, which alternating current is assigned to the respective coils and the direction of the alternating current. When a coil is energized, the coil is marked with a ring with an arrow, wherein the ring bears the pattern of the assigned alternating current and an arrow in the ring indicates the direction of the current.

If the arrow is positioned at the top of the ring, the arrow indicates that the coil is energized as part of the rotary movement. If the arrow is positioned at the bottom of the ring, the arrow indicates that the coil is energized as part of the lifting movement. If an arrow is shown both at the top and bottom of the ring, the coil is energized for both the rotary movement and the lifting movement. If the coil is energized simultaneously for the rotary movement and for the lifting movement, the associated alternating currents are superimposed. The ring on the coil then carries the pattern of the alternating current assigned to the rotary movement in the upper area and the pattern of the alternating current assigned to the lifting movement in the lower area.

Furthermore, the position of the shaft sections of the rotor is displayed for the respective rotary lifting movement shown in the step-by-step diagram.

During the simultaneous rotation of the rotor by 90° and lifting movement of the rotor over the length of two permanent magnets shown in eight steps in FIGS. 22A and 22B to FIGS. 29A and 29B, the rotor is aligned with respect to the stator in such a way that the first shaft section W1 and the second shaft section W2 are covered by the inner circumferential surface of the stator spanned in the first hollow cylinder section H1, the second hollow cylinder section H2 and the third hollow cylinder section H3 of the stator. The third shaft section W3 and the fourth shaft section W4 protrude beyond the hollow cylinder sections when viewed in the z-direction.

The coils of the first hollow cylinder section H1 lie opposite to the permanent magnets of the first shaft section W1 and the coils of the third hollow cylinder section H3 lie opposite to the permanent magnets of the second shaft section W2. In the coils of the second hollow cylinder section H2, the lower half covers the permanent magnets of the first shaft section W1 and the upper half covers the permanent magnets of the second shaft section W2.

In FIG. 21B, the course of the first alternating current PU, the second alternating current PV and the third alternating current PW is shown in a current-time diagram, the different alternating currents being marked with different patterns. In each of the eight step-by-step diagrams of FIGS. 22A and 22B to FIGS. 29A and 29B, the course of the first alternating current PU, the second alternating current PV and the third alternating current PW is shown in a current-time diagram, with the different alternating currents being marked with different patterns. The actual current values are shown with a dashed line for the rotary lifting movement shown in each step-by-step diagram.

FIGS. 22A and 22B show the starting point of the rotary lifting movement.

The coils of the first hollow cylinder section H1 lie opposite to the permanent magnets of the first shaft section W1 and the coils of the third hollow cylinder section H3 lie opposite to the permanent magnets of the second shaft section W2. In the coils of the second hollow cylinder section H2, the upper half covers the permanent magnets of the first shaft section W1 and the lower half covers the permanent magnets of the second shaft section W2.

In the first hollow cylinder section H1, the second half of the first coil H1-C1 and the second coil H1-C2 cover the first south pole permanent magnet W1-S1 of the first shaft section W1 when viewed counterclockwise from the x-direction, and the third coil H1-C3 and the first half of the fourth coil H1-C4 cover the second north pole permanent magnet W1-N2 of the first shaft section W1.

In the second hollow cylinder section H2, the second half of the thirteenth coil H2-C13 and the fourteenth coil H2-C14 cover the first south pole permanent magnet W1-S1 of the first shaft section W1 and the fifteenth coil H2-C15 and the first half of the sixteenth coil H2-C16 cover the second north pole permanent magnet W1-N2 of the first shaft section W1, when viewed counterclockwise from the x-direction.

Furthermore, in the second hollow cylinder section H2, the second half of the thirteenth coil H2-C13 and the fourteenth coil H2-C14 cover the ninth north pole permanent magnet W2-N9 of the second shaft section W2 and the fifteenth coil H2-C15 and the first half of the sixteenth coil H2-C16 cover the tenth south pole permanent magnet W1-S10 of the second shaft section W2, when viewed counterclockwise from the x-direction.

In the third hollow cylinder section H3, the first half of the twenty-fifth coil H3-C25 and the twenty-sixth coil H3-C26 cover the ninth north pole permanent magnet W2-N9 of the second shaft section W2 and the twenty-seventh coil H3-C27 and the second half of the twenty-eighth coil H3-C28 cover the tenth south pole permanent magnet W1-S10 of the second shaft section W2, when viewed counterclockwise from the x-direction.

Viewed in the z-direction, the second half of the first coil H1-C1 of the first hollow cylinder section H1 and the lower half region of the second half of the thirteenth coil H2-C13 of the second hollow cylinder section H2 cover the first south pole permanent magnet W1-S1 of the first shaft section W1 and the upper half region of the second half of the thirteenth coil H2-C13 of the second hollow cylinder section H2 and the second half of the twenty-fifth coil H3-C25 of the third hollow cylinder section H2 cover the first south pole permanent magnet W1-S1 of the second hollow cylinder section H2.region of the second half of the thirteenth coil H2-C13 of the second hollow cylinder section H2 and the second half of the twenty-fifth coil H3-C25 of the third hollow cylinder section H3 the ninth north pole permanent magnet W2-N9 of the second shaft section W2.

Viewed in the z-direction, the second coil H1-C2 of the first hollow cylinder section H1 and the lower half region of the fourteenth coil H2-C14 of the second hollow cylinder section H2 cover the first south pole permanent magnet W1-S1 of the first shaft section W1 and the upper half region of the fourteenth coil H2-C14 of the second hollow cylinder section H2 and the twenty-sixth coil H3-C26 of the third hollow cylinder section H3 cover the first south pole permanent magnet W1-S1 of the first shaft section W1. of the fourteenth coil H2-C14 of the second hollow cylinder section H2 and the twenty-sixth coil H3-C26 of the third hollow cylinder section H3 the ninth north pole permanent magnet W2-N9 of the second shaft section W2.

Viewed in the z-direction, the third coil H1-C3 of the first hollow cylinder section H1 and the lower half-region of the fifteenth coil H2-C15 of the second hollow cylinder section H2 cover the second north pole permanent magnet W1-N2 of the first shaft section W1 and the upper half-region of the fifteenth coil H2-C15 of the second hollow cylinder section H2 and the twenty-seventh coil H3-C27 of the third hollow cylinder section H3 cover the second north pole permanent magnet W1-N2 of the first shaft section W1. of the fifteenth coil H2-C15 of the second hollow cylinder section H2 and the twenty-seventh coil H3-C27 of the third hollow cylinder section H3 the tenth south pole permanent magnet W2-S10 of the second shaft section W2.

Viewed in the z-direction, the first half of the fourth coil H1-C4 of the first hollow cylinder section H1 and the lower half region of the first half of the sixteenth coil H2-C16 of the second hollow cylinder section H2 cover the second north pole permanent magnet W1-N2 of the first shaft section W1 and the upper half region of the first half of the sixteenth coil H2-C16 of the second hollow cylinder section H2 and the first half of the twenty-eighth coil H3-C28 of the third hollow cylinder section H2 cover the second north pole permanent magnet W1-N2 of the second hollow cylinder section H2.region of the first half of the sixteenth coil H2-C16 of the second hollow cylinder section H2 and the first half of the twenty-eighth coil H3-C28 of the third hollow cylinder section H3 the tenth south pole permanent magnet W2-S10 of the second shaft section W2.

In the current-time diagram, which shows the course of the first alternating current PU, of the second alternating current PV and of the third alternating current PW, the coils of the quarter range, which are operated in three-phase alternating current mode, are energized with the current values of the first alternating current PU, of the second alternating current PV and of the third alternating current PW at time 0.00, as indicated by the dashed line.

The perspective view of the quarter section in FIG. 22A shows the current flow at the starting point of the rotary lifting movement.

The second half of the first coil H1-C1 in the first hollow cylinder section H1 is operated with the third alternating current PW for the rotary movement, with the alternating current circulating clockwise in the wire windings.

The second coil H1-C2 in the first hollow cylinder section H1 is operated with both the first alternating current PU and the second alternating current PV, wherein the two alternating currents overlap in the wire windings and the first alternating current PU circulates for the counterclockwise lifting movement and the second alternating current PV for the clockwise rotary movement.

The third coil H1-C3 in the first hollow cylinder section H1 will be operated with the first alternating current PU for the rotary movement and the lifting movement, with the alternating current circulating clockwise in the wire windings.

The first half of the fourth coil H1-C4 in the first hollow cylinder section H1 is operated with the third alternating current PW for the rotary movement, with the alternating current circulating clockwise in the wire windings.

The second half of the thirteenth coil H2-C13 in the second hollow cylinder section H2 is not energized.

The fourteenth coil H1-C14 in the second hollow cylinder section H2 is operated with the third alternating current PW for the lifting movement, wherein the alternating current in the wire windings circulates counterclockwise.

The fifteenth coil H1-C15 in the second hollow cylinder section H2 is operated with the third alternating current PW for the lifting movement, with the alternating current circulating clockwise in the wire windings.

The first half of the sixteenth coil H2-C16 in the second hollow cylinder section H2 is not energized.

The second half of the twenty-fifth coil H1-C25 in the third hollow cylinder section H3 is operated with the third alternating current PW for the rotary movement, with the alternating current circulating counterclockwise in the wire windings.

The twenty-sixth coil H1-C26 in the third hollow cylinder section H3 is operated with the second alternating current PV for the rotary movement and the lifting movement, with the alternating current circulating counterclockwise in the wire windings.

The twenty-seventh coil H1-C2 in the third hollow cylinder section H3 is operated with both the first alternating current PU and the second alternating current PV, wherein the two alternating currents overlap in the wire windings and the first alternating current PU circulates for the counterclockwise rotary movement and the second alternating current PV for the clockwise lifting movement.

The first half of the twenty-eighth coil H3-C28 in the third hollow cylinder section H3 is operated with the third alternating current PW for the rotary movement, with the alternating current circulating counterclockwise in the wire windings.

The energization of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 22A and 22B.

The energization of the coils of the quarter section, as shown in FIGS. 22A and 22B, in contrast to the pure rotation of the rotor through 90° shown in FIGS. 4A-4C to FIGS. 11A-11C and the pure lifting of the rotor over the length of two permanent magnets shown in FIGS. 13A-13C to FIGS. 20A-20C, respectively, the energization of the coils of the quarter section is modified both in terms of the associated alternating current and its current direction as well as the current value in order to generate the traveling magnetic field for the rotation and the lifting movement, respectively.

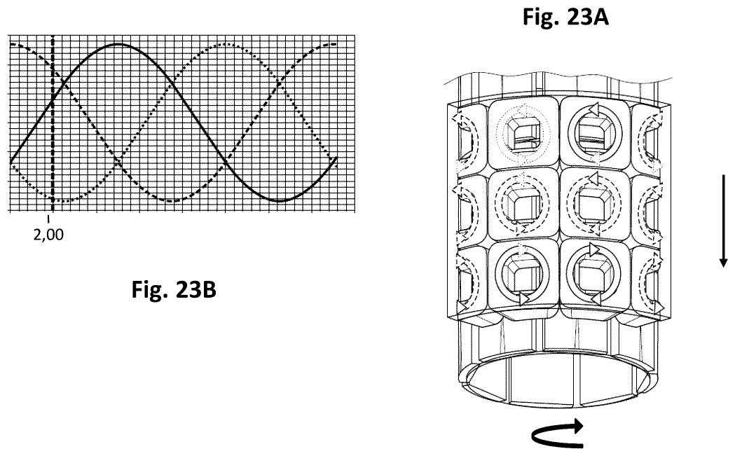

FIGS. 23A and 23B show the rotary lifting actuator 100 after a first rotary lifting step of the rotor by rotation of 12° and by a lifting which is 0.27 times the pole pitch.

As the perspective view shows, the first shaft section W1 of the rotor has moved out of the section of the stator with the three hollow cylinder sections against the z-direction, while the third shaft section W3 of the rotor has moved into the section of the stator with the three hollow cylinder sections. Furthermore, the rows of permanent magnets formed by the superimposed permanent magnets of the first shaft section W1, the second shaft section W2, the third shaft section W3 and the fourth shaft section W4 have rotated counterclockwise (in relation to the arrow shown).

In the current-time diagram, which shows the course of the first alternating current PU, the second alternating current PV and the third alternating current PW, the coils of the quarter range, which are operated in three-phase alternating current mode, are energized with the current values of the first alternating current PU, the second alternating current PV and the third alternating current PW at time 2.00, as indicated by the dashed line.

The perspective view of the quarter area in FIG. 22A now shows the following current flow.

The same current always flows in the first coil H1-C1 and the fourth coil H1-C4. The second half of the first coil H1-C1 in the first hollow cylinder section H1 is operated with both the first alternating current PU and the third alternating current PW, wherein the two alternating currents are superimposed in the wire windings and the first alternating current PU circulates counterclockwise for the lifting movement and the third alternating current PW circulates clockwise for the rotary movement.

The second coil H1-C2 in the first hollow cylinder section H1 is operated with both the first alternating current PU and the second alternating current PV, wherein the two alternating currents are superimposed in the wire windings and the first alternating current PU circulates counterclockwise for the lifting movement and the second alternating current PV circulates clockwise for the rotary movement.

The third coil H1-C3 in the first hollow cylinder section H1 will be operated with the first alternating current PU for the rotary movement and the lifting movement, with the alternating current circulating clockwise in the wire windings.

The first half of the fourth coil H1-C4 in the first hollow cylinder section H1 is operated with both the first alternating current PU and the third alternating current PW, wherein the two alternating currents are superimposed in the wire windings and the first alternating current PU circulates counterclockwise for the lifting movement and the third alternating current PW circulates clockwise for the rotary movement.

The second half of the thirteenth coil H2-C13 in the second hollow cylinder section H2 is operated with the third alternating current PW, wherein the alternating current for the rotary movement and the lifting movement in the wire windings rotates counterclockwise.

The fourteenth coil H2-C14 in the second hollow cylinder section H2 is operated with both the second alternating current PV and the third alternating current PW, with the two alternating currents overlapping in the wire windings and the second alternating current PV circulating counterclockwise for the rotary movement and the third alternating current PW for the lifting movement.

The fifteenth coil H2-C15 in the second hollow cylinder section H2 is operated with both the first alternating current PU and the third alternating current PW, wherein the two alternating currents are superimposed in the wire windings and the first alternating current PU circulates counterclockwise for the rotary movement and the third alternating current PW circulates clockwise for the lifting movement.

The first half of the sixteenth coil H2-C16 in the second hollow cylinder section H2 is operated with the third alternating current PW for the rotary movement and the lifting movement, with the alternating current circulating counterclockwise in the wire windings.

The second half of the twenty-fifth coil H3-C25 in the third hollow cylinder section H3 is operated with both the third alternating current PW and the second alternating current PV, wherein the two alternating currents overlap in the wire windings and the third alternating current PW rotates counterclockwise for the rotary movement and the second alternating current PV rotates counterclockwise for the lifting movement.

The twenty-sixth coil H3-C26 in the third hollow cylinder section H3 is operated with the second alternating current PV for the rotary movement and the lifting movement, with the alternating current circulating counterclockwise in the wire windings.

The twenty-seventh coil H3-C27 in the third hollow cylinder section H3 is operated with both the first alternating current PU and the second alternating current PV, wherein the two alternating currents are superimposed in the wire windings and the first alternating current PU rotates counterclockwise for the rotary movement and the second alternating current PV rotates clockwise for the lifting movement.

The first half of the twenty-eighth coil H3-C28 in the third hollow cylinder section H3 is operated with both the third alternating current PW and the second alternating current PV, wherein the two alternating currents overlap in the wire windings and the third alternating current PW rotates counterclockwise for the rotary movement and the second alternating current PV rotates counterclockwise for the lifting movement.

The energizing of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 22A and 22B.

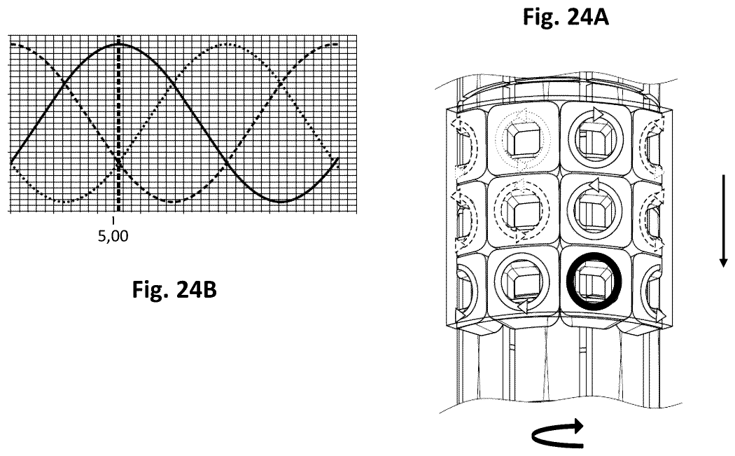

FIGS. 24A and 24B show the rotary lifting actuator 100 after a second rotary lifting step of the rotor with a rotation by 18° to 30° and by a lifting with 0.4 times the pole pitch to a total lifting with 0.67 times the pole pitch.

As the perspective view shows, the first shaft section W1 of the rotor has moved further out of the section of the stator with the three hollow cylinder sections towards the z-direction, while the third shaft section W3 of the rotor has moved into the section of the stator with the three hollow cylinder sections. Furthermore, the rows of permanent magnets formed by the superimposed permanent magnets of the first shaft section W1, the second shaft section W2, the third shaft section W3 and the fourth shaft section W4 have continued to rotate counterclockwise.

In the current-time diagram which shows the course of the first alternating current PU, of the second alternating current PV and of the third alternating current PW, the coils of the quarter range, which are operated in three-phase alternating current mode, are energized with the current values of the first alternating current PU, the second alternating current PV and the third alternating current PW at time 5.00, as indicated by the dashed line.

The perspective view of the quarter area in FIG. 24A now shows the following current flow.

The second half of the first coil H1-C1 in the first hollow cylinder section H1 is operated with the first alternating current PU for the lifting movement, with the alternating current circulating counterclockwise in the wire windings.

The second coil H1-C2 in the first hollow cylinder section H1 is operated with the first alternating current PU for the lifting movement, with the alternating current circulating clockwise in the wire windings.

The third coil H1-C3 in the first hollow cylinder section H1 is not energized.

The first half of the fourth coil H1-C4 in the first hollow cylinder section H1 is operated with the first alternating current PU for the lifting movement, with the alternating current circulating counterclockwise in the wire windings.

The second half of the thirteenth coil H2-C13 in the second hollow cylinder section H2 is operated with the third alternating current PW for the rotary movement and the lifting movement, with the alternating current circulating counterclockwise in the wire windings.

The fourteenth coil H2-C14 in the second hollow cylinder section H2 is operated with both the third alternating current PW and the second alternating current PV, wherein the two alternating currents overlap in the wire windings and the third alternating current PW circulates counterclockwise for the rotary movement and the second alternating current PV for the lifting movement.

The fifteenth coil H2-C15 in the second hollow cylinder section H2 is operated with the first alternating current PU for the rotary movement, wherein the alternating current in the wire windings rotates counterclockwise.

The first half of the sixteenth coil H2-C16 in the second hollow cylinder section H2 is operated with the third alternating current PW for the rotary movement and the lifting movement, with the alternating current circulating counterclockwise in the wire windings.

The second half of the twenty-fifth coil H3-C25 in the third hollow cylinder section H3 is operated with both the third alternating current PW and the second alternating current PV, wherein the two alternating currents overlap in the wire windings and the third alternating current PW rotates counterclockwise for the rotary movement and the second alternating current PV rotates counterclockwise for the lifting movement.

The twenty-sixth coil H3-C26 in the third hollow cylinder section H3 is operated with the second alternating current PV for the rotary movement and the lifting movement, with the alternating current circulating counterclockwise in the wire windings.

The twenty-seventh coil H3-C27 in the third hollow cylinder section H3 is operated with the first alternating current PU for the rotary movement, with the alternating current circulating clockwise in the wire windings.

The first half of the twenty-eighth coil H3-C28 in the third hollow cylinder section H3 is operated with both the third alternating current PW and the second alternating current PV, wherein the two alternating currents overlap in the wire windings and the third alternating current PW rotates counterclockwise for the rotary movement and the second alternating current PV rotates counterclockwise for the lifting movement.

The energizing of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 24A and 24B.

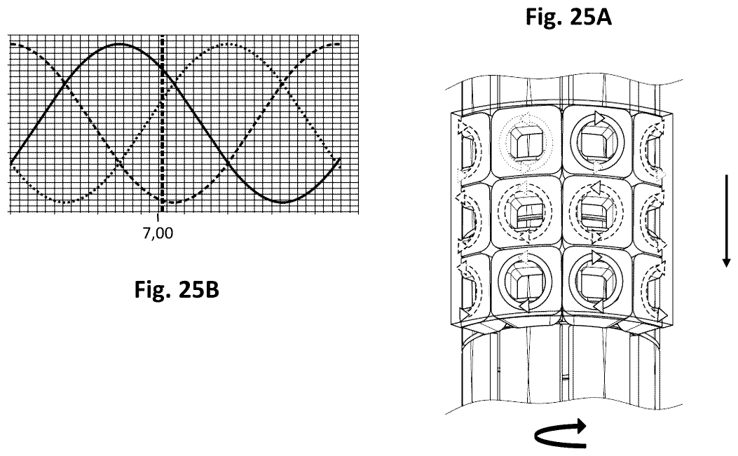

FIGS. 25A and 25B show the rotary lifting actuator 100 after a third rotary lifting step of the rotor by rotation about 12° to 42° and by a lifting of 0.27 times the pole pitch to a total lifting of 0.94 times the pole pitch.

As the perspective view shows, the first shaft section W1 of the rotor has almost completely moved out of the section of the stator with the three hollow cylinder sections against the z-direction, while the third shaft section W3 of the rotor has almost completely moved into the section of the stator with the three hollow cylinder sections. Furthermore, the rows of permanent magnets formed by the superimposed permanent magnets of the first shaft section W1, the second shaft section W2, the third shaft section W3 and the fourth shaft section W4 have continued to rotate counterclockwise.

In the current-time diagram, which shows the course of the first alternating current PU, of the second alternating current PV and of the third alternating current PW, the coils of the quarter range, which are operated in three-phase alternating current mode, are energized with the current values of the first alternating current PU, the second alternating current PV and the third alternating current PW at time 7.00, as indicated by the dashed line.

The perspective view of the quarter area in FIG. 25A now shows the following current flow.

The second half of the first coil H1-C1 in the first hollow cylinder section H1 is operated with both the first alternating current PU and the third alternating current PW, wherein the two alternating currents are superimposed in the wire windings and the first alternating current PU circulates counterclockwise for the lifting movement and the third alternating current PW circulates counterclockwise for the rotary movement.

The second coil H1-C2 in the first hollow cylinder section H1 is operated with both the first alternating current PU and the second alternating current PV, wherein the two alternating currents are superimposed in the wire windings and the first alternating current PU circulates clockwise for the lifting movement and the second alternating current PV circulates counterclockwise for the rotary movement.

The third coil H1-C3 in the first hollow cylinder section H1 is operated with the first alternating current PU for the rotary movement and the lifting movement, with the alternating current circulating clockwise in the wire windings.

The first half of the fourth coil H1-C4 is operated in the first hollow cylinder section H1 with both the first alternating current PU and the third alternating current PW, wherein the two alternating currents are superimposed in the wire windings and the first alternating current PU circulates counterclockwise for the lifting movement and the third alternating current PW circulates counterclockwise for the rotary movement.

The second half of the thirteenth coil H2-C13 in the second hollow cylinder section H2 is operated with the third alternating current PW for the rotary movement and the lifting movement, with the alternating current circulating counterclockwise in the wire windings.

The fourteenth coil H2-C14 in the second hollow cylinder section H2 is operated with both the third alternating current PW and the second alternating current PV, wherein the two alternating currents overlap in the wire windings and the third alternating current PW circulates clockwise for the rotary movement and the second alternating current PV for the lifting movement.

The fifteenth coil H2-C15 in the second hollow cylinder section H2 is operated with both the first alternating current PU and the third alternating current PW, wherein the two alternating currents are superimposed in the wire windings and the first alternating current PU rotates counterclockwise for the rotary movement and the third alternating current PW rotates counterclockwise for the lifting movement.

The first half of the sixteenth coil H2-C16 in the second hollow cylinder section H2 is operated with the third alternating current PW for the rotary movement and the lifting movement, with the alternating current circulating counterclockwise in the wire windings.

The second half of the twenty-fifth coil H3-C25 in the third hollow cylinder section H3 is operated with both the third alternating current PW and the second alternating current PV, wherein the two alternating currents overlap in the wire windings and the third alternating current PW rotates counterclockwise for the rotary movement and the second alternating current PV rotates counterclockwise for the lifting movement.

The twenty-sixth coil H3-C26 in the third hollow cylinder section H3 is operated with the second alternating current PV for the rotary movement and the lifting movement, with the alternating current circulating counterclockwise in the wire windings.

The twenty-seventh coil H3-C27 is operated in the third hollow cylinder section H3 with both the first alternating current PU and the second alternating current PV, wherein the two alternating currents are superimposed in the wire windings and the first alternating current PU circulates clockwise for the rotary movement and the second alternating current PV circulates counterclockwise for the lifting movement.

The first half of the twenty-eighth coil H3-C28 in the third hollow cylinder section H3 is operated with both the third alternating current PW and the second alternating current PV, wherein the two alternating currents overlap in the wire windings and the third alternating current PW rotates counterclockwise for the rotary movement and the second alternating current PV rotates counterclockwise for the lifting movement.

The energizing of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 25A and 25B.

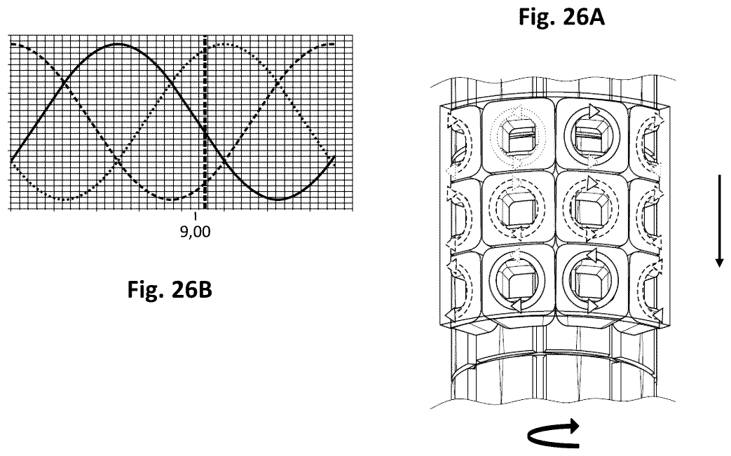

FIGS. 26A and 26B show the rotary lifting actuator 100 after a fourth rotary lifting step of the rotor by rotation about 12° to 54° and by a lifting of 0.27 times the pole pitch to a total lifting of 1.2 times the pole pitch.

As the perspective view shows, the first shaft section W1 and a section of the second shaft section W2 of the rotor have moved out of the section of the stator with the three hollow cylinder sections against the z-direction, while the third shaft section W3 and a section of the fourth shaft section W4 of the rotor have moved into the section of the stator with the three hollow cylinder sections. Furthermore, the rows of permanent magnets formed by the superimposed permanent magnets of the first shaft section W1, the second shaft section W2, the third shaft section W3 and the fourth shaft section W4 have continued to rotate counterclockwise.

In the current-time diagram, which shows the course of the first alternating current PU, of the second alternating current PV and of the third alternating current PW, the coils of the quarter range, which are operated in three-phase alternating current mode, are energized with the current values of the first alternating current PU, the second alternating current PV and the third alternating current PW at time 9.00, as indicated by the dashed line.

The perspective view of the quarter area in FIG. 26A now shows the following current flow.

The second half of the first coil H1-C1 is operated in the first hollow cylinder section H1 with both the first alternating current PU and the third alternating current PW, wherein the two alternating currents are superimposed in the wire windings and the first alternating current PU circulates clockwise for the lifting movement and the third alternating current PW circulates counterclockwise for the rotary movement.

The second coil H1-C2 is operated in the first hollow cylinder section H1 with both the first alternating current PU and the second alternating current PV, wherein the two alternating currents are superimposed in the wire windings and the first alternating current PU circulates clockwise for the lifting movement and the second alternating current PV circulates counterclockwise for the rotary movement.

The third coil H1-C3 in the first hollow cylinder section H1 is operated with the first alternating current PU for the rotary movement and the lifting movement, with the alternating current circulating counterclockwise in the wire windings.

The first half of the fourth coil H1-C4 is operated in the first hollow cylinder section H1 with both the first alternating current PU and the third alternating current PW, wherein the two alternating currents are superimposed in the wire windings and the first alternating current PU circulates clockwise for the lifting movement and the third alternating current PW circulates counterclockwise for the rotary movement.

The second half of the thirteenth coil H2-C13 is operated in the second hollow cylinder section H2 with the third alternating current PW for the rotary movement and the lifting movement, with the alternating current circulating clockwise in the wire windings.

The fourteenth coil H2-C14 in the second hollow cylinder section H2 is operated with both the second alternating current PV and the third alternating current PW, wherein the two alternating currents overlap in the wire windings and the second alternating current PV rotates clockwise for the rotary movement and the third alternating current PW rotates clockwise for the lifting movement.

The fifteenth coil H2-C15 is operated in the second hollow cylinder section H2 with both the first alternating current PU and the third alternating current PW, wherein the two alternating currents are superimposed in the wire windings and the first alternating current PU circulates clockwise for the rotary movement and the third alternating current PW circulates counterclockwise for the lifting movement.

The first half of the sixteenth coil H2-C16 is operated in the second hollow cylinder section H2 with the third alternating current PW for the rotary movement and the lifting movement, with the alternating current circulating clockwise in the wire windings.

The second half of the twenty-fifth coil H3-C25 is operated in the third hollow cylinder section H3 with both the second alternating current PV and the third alternating current PW, wherein the two alternating currents overlap in the wire windings and the second alternating current PV rotates clockwise for the rotary movement and the third alternating current PW rotates clockwise for the lifting movement.

The twenty-sixth coil H3-C26 is operated in the third hollow cylinder section H3 with the second alternating current PV for the rotary movement and the lifting movement, with the alternating current circulating counterclockwise in the wire windings.

The twenty-seventh coil H3-C27 is operated in the third hollow cylinder section H3 with both the first alternating current PU and the second alternating current PV, wherein the two alternating currents are superimposed in the wire windings and the first alternating current PU rotates clockwise for the rotary movement and the second alternating current PV rotates counterclockwise for the lifting movement.

The first half of the twenty-eighth coil H3-C28 in the third hollow cylinder section H3 is operated with both the second alternating current PV and the third alternating current PW, wherein the two alternating currents overlap in the wire windings and the second alternating current PV rotates clockwise for the rotary movement and the third alternating current PW rotates clockwise for the lifting movement.

The energizing of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 26A and 26B.

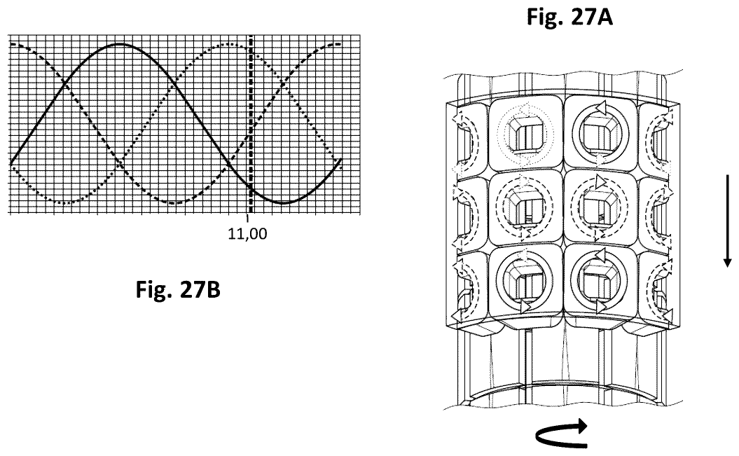

FIGS. 27A and 27B show the rotary lifting actuator 100 after a fifth rotary lifting step of the rotor by rotation about 12° to 66° and by a lifting of 0.27 times the pole pitch to a total lifting of 1.47 times the pole pitch.

As the perspective view shows, a further section of the second shaft section W2 of the rotor has moved out of the section of the stator with the three hollow cylinder sections against the z-direction, while a further section of the fourth shaft section W4 of the rotor has moved into the section of the stator with the three hollow cylinder sections. Furthermore, the rows of permanent magnets formed by the superimposed permanent magnets of the first shaft section W1, the second shaft section W2, the third shaft section W3 and the fourth shaft section W4 have continued to rotate counterclockwise.

In the current-time diagram, which shows the course of the first alternating current PU, the second alternating current PV and the third alternating current PW, the coils of the quarter range, which are operated in three-phase alternating current mode, are energized with the current values of the first alternating current PU, the second alternating current PV and the third alternating current PW at time 11.00, as indicated by the dashed line.

The perspective view of the quarter area in FIG. 27A now shows the following current flow.

The second half of the first coil H1-C1 is operated in the first hollow cylinder section H1 with both the first alternating current PU and the third alternating current PW, wherein the two alternating currents are superimposed in the wire windings and the first alternating current PU circulates clockwise for the lifting movement and the third alternating current PW circulates counterclockwise for the rotary movement.

The second coil H1-C2 is operated in the first hollow cylinder section H1 with both the first alternating current PU and the second alternating current PV, wherein the two alternating currents are superimposed in the wire windings and the first alternating current PU circulates counterclockwise for the lifting movement and the second alternating current PV circulates counterclockwise for the rotary movement.

The third coil H1-C3 in the first hollow cylinder section H1 is operated with the first alternating current PU for the rotary movement and for the lifting movement, with the alternating current circulating counterclockwise in the wire windings.

The first half of the fourth coil H1-C4 in the first hollow cylinder section H1 is operated with both the first alternating current PU and the third alternating current PW, wherein the two alternating currents are superimposed in the wire windings and the first alternating current PU circulates clockwise for the lifting movement and the third alternating current PW circulates counterclockwise for the rotary movement.

The second half of the thirteenth coil H2-C13 in the second hollow cylinder section H2 is operated with the third alternating current PW for the rotary movement and the lifting movement, with the alternating current circulating clockwise in the wire windings.

The fourteenth coil H2-C14 in the second hollow cylinder section H2 is operated with both the second alternating current PV and the third alternating current PW, with the two alternating currents overlapping in the wire windings and the second alternating current PV circulating counterclockwise for the rotary movement and the third alternating current PW for the lifting movement.

The fifteenth coil H2-C15 in the second hollow cylinder section H2 is operated with both the first alternating current PU and the third alternating current PW, wherein the two alternating currents are superimposed in the wire windings and the first alternating current PU circulates clockwise for the rotary movement and the third alternating current PW circulates counterclockwise for the lifting movement.

The first half of the sixteenth coil H2-C16 in the second hollow cylinder section H2 is operated with the third alternating current PW for the rotary movement and the lifting movement, with the alternating current circulating clockwise in the wire windings.

The second half of the twenty-fifth coil H2-C25 in the third hollow cylinder section H3 is operated with both the second alternating current PV and the third alternating current PW, wherein the two alternating currents overlap in the wire windings and the second alternating current PV circulates clockwise for the lifting movement and the third alternating current PW circulates counterclockwise for the rotary movement.

The twenty-sixth coil H3-C26 in the third hollow cylinder section H3 is operated with the second alternating current PV for the rotary movement and the lifting movement, with the alternating current circulating counterclockwise in the wire windings.

The twenty-seventh coil H3-C27 in the third hollow cylinder section H3 is operated with both the first alternating current PU and the second alternating current PV, wherein the two alternating currents overlap in the wire windings and the first alternating current PU circulates for the counterclockwise rotary movement and the second alternating current PV for the counterclockwise lifting movement.

The first half of the twenty-eighth coil H3-C28 in the third hollow cylinder section H3 is operated with both the second alternating current PV and the third alternating current PW, with the two alternating currents overlapping in the wire windings and the second alternating current PV circulating clockwise for the lifting movement and the third alternating current PW circulating counterclockwise for the rotary movement.

The energizing of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 27A and 27B.

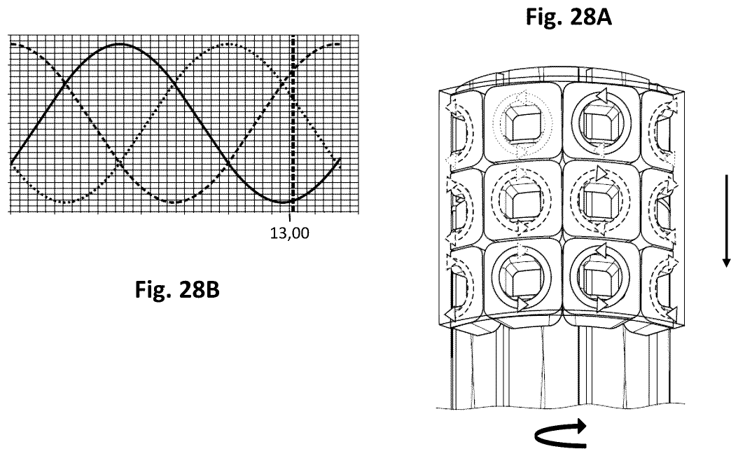

FIGS. 28A and 28B shows the rotary lifting actuator 100 after a sixth rotary lifting step of the rotor by rotation about 12° to 78° and by a lifting of 0.27 times the pole pitch to a total lifting of 1.73 times the pole pitch.

As the perspective view shows, a further section of the second shaft section W2 of the rotor has moved out of the section of the stator with the three hollow cylinder sections against the z-direction, while a further section of the fourth shaft section W4 of the rotor has moved into the section of the stator with the three hollow cylinder sections. Furthermore, the rows of permanent magnets formed by the superimposed permanent magnets of the first shaft section W1, the second shaft section W2, the third shaft section W3 and the fourth shaft section W4 have continued to rotate counterclockwise.

In the current-time diagram, which shows the course of the first alternating current PU, the second alternating current PV and the third alternating current PW, the coils of the quarter range, which are operated in three-phase alternating current mode, are energized with the current values of the first alternating current PU, the second alternating current PV and the third alternating current PW at time 13.00, as indicated by the dashed line.

The perspective view of the quarter area in FIG. 28A now shows the following energization.

The second half of the first coil H1-C1 in the first hollow cylinder section H1 is operated with both the first alternating current PU and the third alternating current PW, wherein the two alternating currents are superimposed in the wire windings and the first alternating current PU circulates clockwise for the lifting movement and the third alternating current PW circulates clockwise for the rotary movement.

The second coil H1-C2 in the first hollow cylinder section H1 is operated with both the first alternating current PU and the second alternating current PV, wherein the two alternating currents are superimposed in the wire windings and the first alternating current PU circulates counterclockwise for the lifting movement and the second alternating current PV circulates clockwise for the rotary movement.

The third coil H1-C3 in the first hollow cylinder section H1 is operated with the first alternating current PU for the rotary movement and the lifting movement, with the alternating current circulating counterclockwise in the wire windings.

The first half of the fourth coil H1-C4 in the first hollow cylinder section H1 is operated with both the first alternating current PU and the third alternating current PW, wherein the two alternating currents overlap in the wire windings and the first alternating current PU circulates clockwise for the lifting movement and the third alternating current PW circulates clockwise for the rotary movement.

The second half of the thirteenth coil H2-C13 in the second hollow cylinder section H2 is operated with the third alternating current PW for the rotary movement and the lifting movement, with the alternating current circulating clockwise in the wire windings.

The fourteenth coil H2-C14 in the second hollow cylinder section H2 is operated with both the second alternating current PV and the third alternating current PW, with the second alternating current PV rotating clockwise for the rotary movement in the wire windings and the third alternating current PW rotating counterclockwise for the lifting movement in the wire windings.

The fifteenth coil H2-C15 in the second hollow cylinder section H2 is operated with both the first alternating current PU and the third alternating current PW, wherein the two alternating currents are superimposed in the wire windings and the first alternating current PU circulates clockwise for the rotary movement and the third alternating current PW circulates clockwise for the lifting movement.

The first half of the sixteenth coil H2-C16 in the second hollow cylinder section H2 is operated with the third alternating current PW for the rotary movement and the lifting movement, with the alternating current circulating clockwise in the wire windings.

The second half of the twenty-fifth coil H2-C25 in the third hollow cylinder section H3 is operated with both the second alternating current PV and the third alternating current PW, with the second alternating current PV circulating counterclockwise for the rotary movement in the wire windings and the third alternating current PW circulating clockwise for the lifting movement in the wire windings.

The twenty-sixth coil H3-C26 in the third hollow cylinder section H3 is operated with the second alternating current PV for the rotary movement and the lifting movement, with the alternating current circulating counterclockwise in the wire windings.

The twenty-seventh coil H3-C27 in the third hollow cylinder section H3 is operated with both the first alternating current PU and the second alternating current PV, wherein the two alternating currents are superimposed in the wire windings and the first alternating current PU circulates for the counterclockwise rotary movement and the second alternating current PV circulates for the clockwise lifting movement.

The first half of the twenty-eighth coil H3-C28 in the third hollow cylinder section H3 is operated with both the second alternating current PV and the third alternating current PW, with the second alternating current PV circulating counterclockwise for the rotary movement in the wire windings and the third alternating current PW circulating clockwise for the lifting movement in the wire windings.

The energizing of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 28A and 28B.

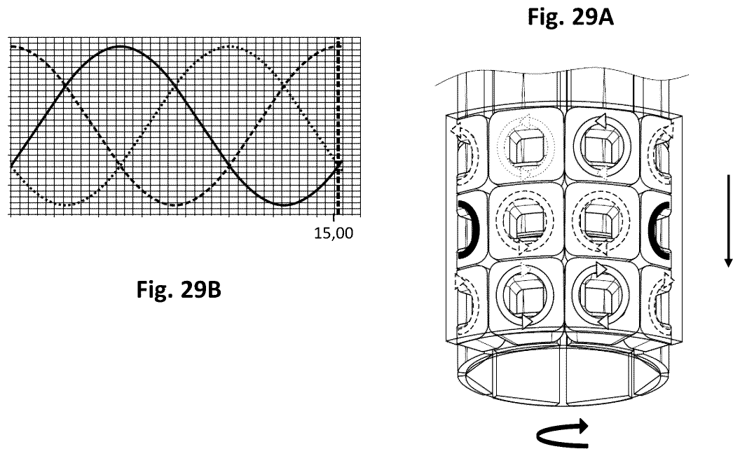

FIGS. 29A and 29B show the end point of the rotary lifting movement. After a seventh rotation-lifting step of the rotor, the rotation-lifting actuator 100 has achieved a rotation of 12° to 90° and a lifting of 0.27 times the pole pitch to a total lifting of 2 times the pole pitch.

In addition to the first shaft section, the second shaft section W2 of the rotor, as shown in the perspective view, has also moved out of the section of the stator with the three hollow cylinder sections against the z-direction, while the fourth shaft section W4 of the rotor has moved into the section of the stator with the three hollow cylinder sections in addition to the third shaft section W3. Furthermore, the rows of permanent magnets formed by the superimposed permanent magnets of the first shaft section W1, the second shaft section W2, the third shaft section W3 and the fourth shaft section W4 have continued to rotate counterclockwise.

The coils of the first hollow cylinder section H1 are opposite to the permanent magnets of the third shaft section W3 and the coils of the third hollow cylinder section H3 are opposite to the permanent magnets of the fourth shaft section W4. In the coils of the second hollow cylinder section H2, the lower half covers the permanent magnets of the third shaft section W3 and the upper half covers the permanent magnets of the fourth shaft section W4.

In the first hollow cylinder section H1, the second half of the first coil H1-C1 and the second coil H1-C2 cover the nineteenth south pole permanent magnet W3-S19 of the third shaft section W3 and the third coil H1-C3 and the first half of the fourth coil H1-C4 cover the twentieth north pole permanent magnet W3-N20 of the third shaft section W3, when viewed counterclockwise from the x-direction.

In the second hollow cylinder section H2, the second half of the thirteenth coil H2-C13 and the fourteenth coil H2-C14 cover the nineteenth south pole permanent magnet W3-S19 of the third shaft section W3 and the fifteenth coil H2-C15 and the first half of the sixteenth coil H2-C16 cover the twentieth north pole permanent magnet W3-N20 of the third shaft section W3, when viewed counterclockwise from the x-direction.

Furthermore, in the second hollow cylinder section H2, the second half of the thirteenth coil H2-C13 and the fourteenth coil H2-C14 cover the twenty-seventh north pole permanent magnet W4-N27 of the fourth shaft section W4 and the fifteenth coil H2-C15 and the first half of the sixteenth coil H2-C16 cover the twenty-eighth south pole permanent magnet W4-S28 of the fourth shaft section W4, when viewed counterclockwise from the x-direction.

In the third hollow cylinder section H3, seen counterclockwise from the x-direction, the first half of the twenty-fifth coil H3-C25 and the twenty-sixth coil H3-C26 cover the twenty-seventh north pole permanent magnet W4-N27 of the fourth shaft section W4 and the twenty-seventh coil H3-C27 and the second half of the twenty-eighth coil H3-C28 cover the twenty-eighth south pole permanent magnet W4-S28 of the fourth shaft section W4.

Viewed in the z-direction, the second half of the first coil H1-C1 of the first hollow cylinder section H1 and the lower half region of the second half of the thirteenth coil H2-C13 of the second hollow cylinder section H2 cover the nineteenth south pole permanent magnet W3-S19 of the third shaft section W3 and the upper half of the second half of the thirteenth coil H2-C13 of the second hollow cylinder section H2 and the second half of the twenty-fifth coil H3-C25 of the third hollow cylinder section H3 the twenty-seventh north pole permanent magnet W4-N27 of the fourth shaft section W4.

Viewed in the z-direction, the second coil H1-C2 of the first hollow cylinder section H1 and the lower half-region of the fourteenth coil H2-C14 of the second hollow cylinder section H2 cover the nineteenth south pole permanent magnet W3-S19 of the third shaft section W3 and the upper half-region of the fourteenth coil H2-C14 of the second hollow cylinder section H2 and the twenty-sixth coil H3-C26 of the third hollow cylinder section H3 the twenty-seventh north pole permanent magnet W4-N27 of the fourth shaft section W4.

Viewed in the z-direction, the third coil H1-C3 of the first hollow cylinder section H1 and the lower half region of the fifteenth coil H2-C15 of the second hollow cylinder section H2 cover the twentieth north pole permanent magnet W3-N20 of the third shaft section W3 and the upper half region of the fifteenth coil H2-C15 of the second hollow cylinder section H2 and the twenty-seventh coil H3-C27 of the third hollow cylinder section H3 cover the second hollow cylinder section H2.region of the fifteenth coil H2-C15 of the second hollow cylinder section H2 and the twenty-seventh coil H3-C27 of the third hollow cylinder section H3 the twenty-eighth south pole permanent magnet W4-S28 of the fourth shaft section W4.

Viewed in the z-direction, the first half of the fourth coil H1-C4 of the first hollow cylinder section H1 and the lower half region of the first half of the sixteenth coil H2-C16 of the second hollow cylinder section H2 cover the twentieth north pole permanent magnet W3-N20 of the third shaft section W3 and the upper half region of the first half of the sixteenth coil H2-C16 of the second hollow cylinder section H2 and the first half of the twenty-eighth coil H3-C28 of the third hollow cylinder section H2 cover the second hollow cylinder section H2.region of the first half of the sixteenth coil H2-C16 of the second hollow cylinder section H2 and the first half of the twenty-eighth coil H3-C28 of the third hollow cylinder section H3 the twenty-eighth south pole permanent magnet W4-S28 of the fourth shaft section W4.

In the current-time diagram, which shows the course of the first alternating current PU, the second alternating current PV and the third alternating current PW, the coils of the quarter range, which are operated in three-phase alternating current mode, are energized with the current values of the first alternating current PU, the second alternating current PV and the third alternating current PW at the time 15.00, as indicated by the dashed line.

The perspective view of the quarter section in FIG. 29A shows the current flow at the end point of the rotary lifting movement, which corresponds to the current flow at the starting point of the rotary lifting movement in FIGS. 22A and 22B.

The second half of the first coil H1-C1 in the first hollow cylinder section H1 is operated with the third alternating current PW for the rotary movement, with the alternating current circulating clockwise in the wire windings.

The second coil H1-C2 in the first hollow cylinder section H1 is operated with both the first alternating current PU and the second alternating current PV, wherein the two alternating currents overlap in the wire windings and the first alternating current PU circulates for the counterclockwise lifting movement and the second alternating current PV for the clockwise rotary movement.

The third coil H1-C3 in the first hollow cylinder section H1 is operated with the first alternating current PU for the rotary movement and the lifting movement, with the alternating current circulating clockwise in the wire windings.

The first half of the fourth coil H1-C4 in the first hollow cylinder section H1 is operated with the third alternating current PW for the rotary movement, with the alternating current circulating clockwise in the wire windings.

The second half of the thirteenth coil H2-C13 in the second hollow cylinder section H2 is not energized.

The fourteenth coil H2-C14 in the second hollow cylinder section H2 is operated with the third alternating current PW for the lifting movement, wherein the alternating current in the wire windings circulates counterclockwise.

The fifteenth coil H2-C15 in the second hollow cylinder section H2 is operated with the third alternating current PW for the lifting movement, with the alternating current circulating clockwise in the wire windings.

The first half of the sixteenth coil H2-C16 in the second hollow cylinder section H2 is not energized.

The second half of the twenty-fifth coil H3-C25 in the third hollow cylinder section H3 is operated with the third alternating current PW for the rotary movement, wherein the alternating current in the wire windings rotates counterclockwise.

The twenty-sixth coil H3-C26 in the third hollow cylinder section H3 is operated with the second alternating current PV for the rotary movement and the lifting movement, with the alternating current circulating counterclockwise in the wire windings.

The twenty-seventh coil H1-C27 in the third hollow cylinder section H3 is operated with both the first alternating current PU and the second alternating current PV, wherein the two alternating currents are superimposed in the wire windings and the first alternating current PU circulates for the counterclockwise rotary movement and the second alternating current PV for the clockwise lifting movement.

The first half of the twenty-eighth coil H3-C28 in the third hollow cylinder section H3 is operated with the third alternating current PW for the rotary movement, with the alternating current circulating counterclockwise in the wire windings.

The energization of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections in FIGS. 29A and 29B.

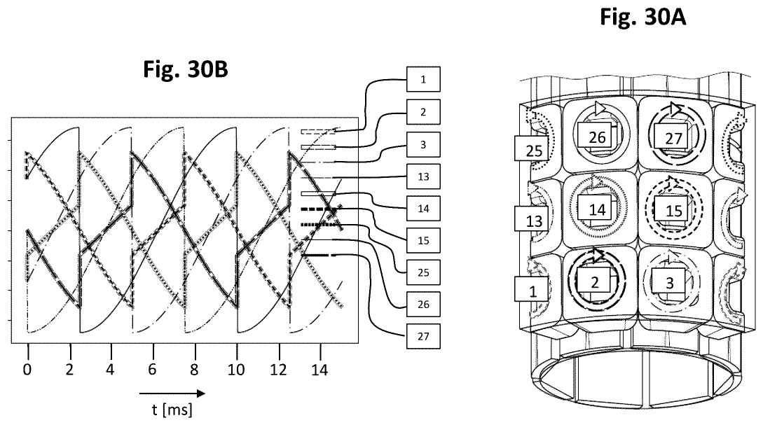

FIG. 30A shows the coils in the three hollow cylinder sections of the stator shown in the quarter area of the rotary lifting actuator. The current curve is shown in FIG. 30B for the coils in the three hollow cylinder sections of the stator shown in the quarter area of the rotary lifting actuator as shown in FIG. 30A. FIG. 30B shows the current flow of the rotary lifting actuator 100 over time for the combination of the rotation of the rotor through 90° with the lifting of the rotor over the length of two permanent magnets from time 0.00 in the current-time diagram to time 15.00 in the current-time diagram, as shown in FIGS. 22A and 22B to FIGS. 29A and 29B.

The current in the first coil H1-C1 and the fourth coil H1-C4 is identical. The same applies to the thirteenth coil H2-C13 and the sixteenth coil H2-C16 as well as the twenty-fifth coil H3-C25 and the twenty-eighth coil H2-C28. For the first hollow cylinder section H1, the current flow of the first coil H1-C1 is labeled with a 1 and shown with a first pattern in the current-time diagram, the second coil H1-C2 is labeled with a 2 and shown with a second pattern in the current-time diagram and the third coil H1-C3 is labeled with a 3 and shown with a third pattern in the current-time diagram. For the second hollow cylinder section H2, the current flow of the thirteenth coil H2-C13 is indicated with a 13 and shown with a fourth pattern in the current-time diagram, the fourteenth coil H2-C14 is labeled with a 14 and shown with a fifth pattern in the current-time diagram and the fifteenth coil H2-C15 is labeled with a 15 and shown with a sixth pattern in the current-time diagram. For the third hollow cylinder section H3, the current flow of the twenty-fifth coil H3-C25 is labeled with a 25 and shown with a seventh pattern in the current-time diagram, the twenty-sixth coil H3-C26 is labeled with a 26 and shown with an eighth pattern in the current-time diagram, and the twenty-seventh coil H3-C27 is labeled with a 27 and shown with a ninth pattern in the current-time diagram.

The energizing of the quarter area of the three hollow cylinder sections of the stator is carried out identically in the other three-quarter areas of the three hollow cylinder sections of the stator. If further groups of three hollow cylinder sections are provided, as shown in FIG. 1E, each further group of three hollow cylinder sections is then energized in the same way as the group of three hollow cylinder sections.

Starting from the energizing of the coils of the quarter section, as shown in FIGS. 29A and 29B, a further simultaneous rotation of the rotor through 90° and a lifting of the rotor over the length of two permanent magnets may be carried out, as shown in FIGS. 22A and 22B to FIGS. 29A and 29B.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

What is claimed is:

1. A rotary lifting actuator comprising:
a hollow cylindrical stator and a rotor which is arranged coaxially in the hollow cylindrical stator, and
a controller;
wherein the stator comprises a plurality of hollow cylinder sections, each hollow cylinder section comprising a plurality of coils arranged over the hollow cylinder section circumference in a distributed manner,
wherein the rotor comprises a plurality of shaft sections, wherein each shaft section comprises a plurality of permanent magnets arranged over the shaft section circumference in a distributed manner, wherein the polarity of the permanent magnets of the rotor alternates in such a way that a checkerboard pattern is produced, and
wherein the controller is configured to energize the coils of the hollow cylinder sections of the stator for the rotary movement of the rotor in such a way that a traveling magnetic field is generated along the hollow cylinder sections;
wherein the energized coil rows along the hollow cylinder sections are at least in part energized alternately in opposite directions, and/or
wherein the controller is configured to energize the coils of the hollow cylinder sections of the stator for the lifting movement of the rotor in such a way that a traveling magnetic field is generated transversely with regard to the hollow cylinder sections, the energized coil rows being energized transversely with regard to the hollow cylinder sections at least partially alternately in opposite directions.

2. The rotary lifting actuator according to claim 1,
wherein the permanent magnets form a ring on the shaft section circumference of each shaft section,
wherein the permanent magnets on the shaft section circumference of the shaft section each have the shape of a curved rectangle,
wherein the polarity of the adjacent permanent magnets on the shaft section alternates in each case, and
wherein the shaft sections are each arranged in such a way that the polarity of the adjacent permanent magnets of neighboring shaft sections alternates.

3. The rotary lifting actuator according to claim 1, wherein the number of coils per hollow cylinder section is larger than the number of permanent magnets per shaft section.

4. The rotary lifting actuator according to claim 1,
wherein the coils are operated in a three-phase alternating current mode,
wherein each hollow cylinder section comprises three coils or an N-fold of the three coils, respectively, on its circumference in a distributed manner, and
wherein three hollow cylinder sections or an N-fold of the three hollow cylinder sections are provided in the longitudinal direction of the hollow cylindrical stator.

5. The rotary lifting actuator according to claim 4, wherein an outer circumferential surface of the rotor spanned by four permanent magnets in two shaft sections of the rotor is covered by an inner circumferential surface of the stator spanned by the nine coils in three hollow cylinder sections of the stator.

6. The rotary lifting actuator according to claim 5,
wherein the controller is configured to energize two rows of coils in opposite directions along the hollow cylinder sections for the rotary movement of the rotor of the three adjacent hollow cylinder sections, and
wherein the controller is configured to energize two rows of coils transversely with regard to the hollow cylinder sections in opposite directions for the lifting movement of the rotor in the three adjacent hollow cylinder sections.

7. The rotary lifting actuator according to claim 6,
wherein the controller is configured not to energize a coil row along the hollow cylinder sections for the rotary movement of the rotor of the three adjacent hollow cylinder sections, and
wherein the controller is configured not to energize a coil row transversely with regard to the hollow cylinder sections for the lifting movement of the rotor in the three adjacent hollow cylinder sections.

8. The rotary lifting actuator according to claim 1, wherein the controller is configured to apply alternating current individually to the coils of the hollow cylinder sections of the stator in order to adjust the phase current in the respective coil, which is necessary for the traveling magnetic field to be generated along the hollow cylinder sections and for the traveling magnetic field to be generated transversely with regard to the hollow cylinder sections in order to carry out a predetermined lifting and/or rotary movement of the rotor.

9. The rotary lifting actuator according to claim 1, wherein the controller is configured to energize hollow cylinder sections of the stator for the rotary movement of the rotor and further hollow cylinder sections of the stator for the lifting movement of the rotor in order to carry out a predetermined rotary and lifting movement of the rotor.

10. The rotary lifting actuator according to claim 1, wherein a regular grid of coil cores is implemented on an inner housing wall of the stator, each coil core carrying a wire winding.

11. The rotary lifting actuator according to claim 1 comprising:
a piston rod, and
a cylindrical tube housing which comprises a bearing cap at each of the two ends;
wherein each bearing cap comprises a guide ring and a wiper having a through hole,
wherein the plurality of hollow cylinder sections of the stator is arranged on the inner wall of the housing,
wherein the outer circumference of the piston rod comprises the plurality of shaft sections of the rotor, and
wherein the piston rod extends through the guide rings and the through holes in the wipers of the two bearing caps.

12. The rotary lifting actuator according to claim 11, wherein a position sensor for detecting the position of the piston rod is provided in the cylindrical tube housing.

13. A rotary lifting actuator comprising:
a hollow cylindrical stator and a rotor which is arranged coaxially in the hollow cylindrical stator, and
a controller;
wherein the stator comprises a plurality of hollow cylinder sections, each hollow cylinder section comprising a plurality of coils arranged over the hollow cylinder section circumference in a distributed manner,
wherein the rotor comprises a plurality of shaft sections, wherein each shaft section comprises a plurality of permanent magnets arranged over the shaft section circumference in a distributed manner,
wherein the polarity of the permanent magnets of the rotor alternates in such a way that a checkerboard pattern is produced,
wherein the coils are operated in a three-phase alternating current mode,
wherein each hollow cylinder section comprises three coils or an N-fold of the three coils, respectively, on its circumference in a distributed manner,
wherein three hollow cylinder sections or an N-fold of the three hollow cylinder sections are provided in the longitudinal direction of the hollow cylindrical stator, and
wherein an outer circumferential surface of the rotor spanned by four permanent magnets in two shaft sections of the rotor is covered by an inner circumferential surface of the stator spanned by the nine coils in three hollow cylinder sections of the stator.

14. The rotary lifting actuator according to claim 13,
wherein the controller is configured to energize two rows of coils in opposite directions along the hollow cylinder sections for the rotary movement of the rotor of the three adjacent hollow cylinder sections, and
wherein the controller is configured to energize two rows of coils transversely with regard to the hollow cylinder sections in opposite directions for the lifting movement of the rotor in the three adjacent hollow cylinder sections.

15. The rotary lifting actuator according to claim 14,
wherein the controller is configured not to energize a coil row along the hollow cylinder sections for the rotary movement of the rotor of the three adjacent hollow cylinder sections, and
wherein the controller is configured not to energize a coil row transversely with regard to the hollow cylinder sections for the lifting movement of the rotor in the three adjacent hollow cylinder sections.

16. A rotary lifting actuator according to claim 13,
wherein the controller is configured to energize the coils of the hollow cylinder sections of the stator for the rotary movement of the rotor in such a way that a traveling magnetic field is generated along the hollow cylinder sections,
wherein the energized coil rows along the hollow cylinder sections are at least in part energized alternately in opposite directions, and/or
wherein the controller is configured to energize the coils of the hollow cylinder sections of the stator for the lifting movement of the rotor in such a way that a traveling magnetic field is generated transversely with regard to the hollow cylinder sections, the energized coil rows being energized transversely with regard to the hollow cylinder sections at least partially alternately in opposite directions.

17. The rotary lifting actuator according to claim 13,
wherein the permanent magnets form a ring on the shaft section circumference of each shaft section,
wherein the permanent magnets on the shaft section circumference of the shaft section each have the shape of a curved rectangle,
wherein the polarity of the adjacent permanent magnets on the shaft section alternates in each case, and
wherein the shaft sections are each arranged in such a way that the polarity of the adjacent permanent magnets of neighboring shaft sections alternates.

18. The rotary lifting actuator according to claim 13, wherein the number of coils per hollow cylinder section is larger than the number of permanent magnets per shaft section.

19. A rotary lifting actuator comprising:
a hollow cylindrical stator and a rotor which is arranged coaxially in the hollow cylindrical stator, and
a controller,
wherein the stator comprises a plurality of hollow cylinder sections, each hollow cylinder section comprising a plurality of coils arranged over the hollow cylinder section circumference in a distributed manner,
wherein the rotor comprises a plurality of shaft sections, wherein each shaft section comprises a plurality of permanent magnets arranged over the shaft section circumference in a distributed manner,
wherein the polarity of the permanent magnets of the rotor alternates in such a way that a checkerboard pattern is produced,
wherein the permanent magnets form a ring on the shaft section circumference of each shaft section,
wherein the permanent magnets on the shaft section circumference of the shaft section each have the shape of a curved rectangle,
wherein the polarity of the adjacent permanent magnets on the shaft section alternates in each case, and
wherein the shaft sections are each arranged in such a way that the polarity of the adjacent permanent magnets of neighboring shaft sections alternates.

20. The rotary lifting actuator according to claim 19,
wherein the controller is configured to energize the coils of the hollow cylinder sections of the stator for the rotary movement of the rotor in such a way that a traveling magnetic field is generated along the hollow cylinder sections,
wherein the energized coil rows along the hollow cylinder sections are at least in part energized alternately in opposite directions, and/or
wherein the controller is configured to energize the coils of the hollow cylinder sections of the stator for the lifting movement of the rotor in such a way that a traveling magnetic field is generated transversely with regard to the hollow cylinder sections, the energized coil rows being energized transversely with regard to the hollow cylinder sections at least partially alternately in opposite directions.
